(19) United States
(12) Patent Application Publication
(10) Pub. No.: US 2024/0292254 A1
(43) Pub. Date: Aug. 29, 2024

(54) METHOD AND DEVICE FOR TRANSMITTING AND RECEIVING CHANNEL STATE INFORMATION IN WIRELESS LAN SYSTEM

(71) Applicant: LG Electronics Inc., Seoul (KR)

(72) Inventors: Jinyoung CHUN, Seoul (KR); Jinsoo CHOI, Seoul (KR); Dongguk LIM, Seoul (KR); Eunsung PARK, Seoul (KR)

(21) Appl. No.: 18/568,685

(22) PCT Filed: Jun. 3, 2022
(86) PCT No.: PCT/KR2022/007938

§ 371 Date: Dec. 8, 2023

(30) Foreign Application Priority Data
Jun. 9, 2021 (KR) 10-2021-0074952

(51) Int. Cl. H04W 24/10; H04W 84/12

(52) U.S. Cl. CPC H04W 24/10; H04W 84/12

(57) ABSTRACT

A method and a device for transmission based on a duplication (DUP) mode related to frequency unit puncturing in a wireless LAN system are disclosed. A method for transmitting or receiving a physical layer protocol data unit (PPDU) by a station (STA) in a wireless LAN system according to an embodiment of the present disclosure may comprise the steps of: receiving, from an access point (AP), information related to whether a duplication (DUP) mode is supported; and transmitting or receiving the PPDU on the basis of whether the DUP mode is supported, wherein the information related to whether the DUP mode is supported is included in the same one frame as that for information related to puncturing of one or more frequency units within a basic service set (BSS) bandwidth.

### TECHNICAL FIELD

The present disclosure relates to a wireless local area network (WLAN) system, and more specifically to a method and device for transmitting and receiving channel state information in a WLAN system.

### BACKGROUND ART

New technologies for improving transmission rates, increasing bandwidth, improving reliability, reducing errors, and reducing latency have been introduced for a wireless LAN (WLAN). Among WLAN technologies, an Institute of Electrical and Electronics Engineers (IEEE) 802.11 series standard may be referred to as Wi-Fi. For example, technologies recently introduced to WLAN include enhancements for Very High-Throughput (VHT) of the 802.11ac standard, and enhancements for High Efficiency (HE) of the IEEE 802.11ax standard.

In order to provide a more improved wireless communication environment, an enhancement technologies for EHT (Extremely High Throughput) are being discussed. For example, technologies for multiple access point (AP) coordination and multiple input multiple output (MIMO) supporting an increased bandwidth, efficient utilization of multiple bands and increased spatial streams are being studied, and, in particular, various technologies for supporting low latency or real-time traffic are being studied.

### DISCLOSURE

### Technical Problem

The technical object of the present disclosure is to provide a method and device for transmitting and receiving channel state information for multi-access point (AP) to support multi-AP operations in a WLAN system.

The technical object of the present disclosure is to provide a frame configuration method and device for transmitting and receiving channel state information for multi-AP.

The technical objects to be achieved by the present disclosure are not limited to the above-described technical objects, and other technical objects which are not described herein will be clearly understood by those skilled in the pertinent art from the following description.

### Technical Solution

A method for transmitting channel state information in a WLAN system according to an aspect of the present disclosure may comprise: receiving, from an access point (AP), a first frame containing request information for requesting channel state measurement for multiple APs; and transmitting, to the AP, a second frame containing channel state information for multiple APs. Herein, the request information and the channel state information may be included in fields for multiple AP link adaptation control in the first frame and the second frame, respectively, and the channel state information may include channel measurement values for each of multiple APs measured by the STA.

A method for receiving channel state information in a WLAN system according to another aspect of the present disclosure may comprise: transmitting, to a station (STA), a first frame containing request information for requesting channel state measurement for multiple APs; and receiving, from the STA, a second frame containing channel state information for multiple APs. Herein, the request information and the channel state information may be included in fields for multiple AP link adaptation control in the first frame and the second frame, respectively, and the channel state information may include channel measurement values for each of multiple APs measured by the STA.

### Advantageous Effects

According to an embodiment of the present disclosure, selection of channels for multi-AP operations may be easily supported.

Additionally, according to an embodiment of the present disclosure, signaling overhead for transmitting and receiving channel state information for multi-AP may be reduced.

Effects achievable by the present disclosure are not limited to the above-described effects, and other effects which are not described herein may be clearly understood by those skilled in the pertinent art from the following description.

### DESCRIPTION OF DRAWINGS

The accompanying drawings, which are included as part of the detailed description to aid understanding of the present disclosure, provide embodiments of the present disclosure and together with the detailed description describe technical features of the present disclosure.

FIG. 1 illustrates a block configuration diagram of a wireless communication device according to an embodiment of the present disclosure.

FIG. 2 is a diagram illustrating an exemplary structure of a WLAN system to which the present disclosure may be applied.

FIG. 3 is a diagram for explaining a link setup process to which the present disclosure may be applied.

FIG. 4 is a diagram for explaining a backoff process to which the present disclosure may be applied.

FIG. 5 is a diagram for explaining a frame transmission operation based on CSMA/CA to which the present disclosure may be applied.

FIG. 6 is a diagram for explaining an example of a frame structure used in a WLAN system to which the present disclosure may be applied.

FIG. 7 is a diagram illustrating examples of PPDUs defined in the IEEE 802.11 standard to which the present disclosure may be applied.

FIGS. 8 to 10 are diagrams for explaining examples of resource units of a WLAN system to which the present disclosure may be applied.

FIG. 11 illustrates an example structure of a HE-SIG-B field.

FIG. 12 is a diagram for explaining a MU-MIMO method in which a plurality of users/STAs are allocated to one RU.

FIG. 13 illustrates an example of a PPDU format to which the present disclosure may be applied.

FIG. 14 illustrates an example of the A-Control subfield to which the present disclosure may be applied.

FIG. 15 is a diagram illustrating a multi-AP link adaptation control field according to an embodiment of the present disclosure.

FIG. 16 is a diagram illustrating a multi-AP link adaptation control field according to an embodiment of the present disclosure.

FIG. 17 is a diagram illustrating a multi-AP link adaptation control field according to an embodiment of the present disclosure.

FIG. 18 is a diagram illustrating an operation of an STA for a method for transmitting and receiving channel state information according to an embodiment of the present disclosure.

FIG. 19 is a diagram illustrating an operation of an AP for a method for transmitting and receiving channel state information according to an embodiment of the present disclosure.

### BEST MODE

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

Examples of the present disclosure may be applied to various wireless communication systems. For example, examples of the present disclosure may be applied to a wireless LAN system. For example, examples of the present disclosure may be applied to an IEEE 802.11a/g/n/ac/ax standards-based wireless LAN. Furthermore, examples of the present disclosure may be applied to a wireless LAN based on the newly proposed IEEE 802.11be (or EHT) standard. Examples of the present disclosure may be applied to an IEEE 802.11be Release-2 standard-based wireless LAN corresponding to an additional enhancement technology of the IEEE 802.11be Release-1 standard. Additionally, examples of the present disclosure may be applied to a next-generation standards-based wireless LAN after IEEE 802.11be. Further, examples of this disclosure may be applied to a cellular wireless communication system. For example, it may be applied to a cellular wireless communication system based on Long Term Evolution (LTE)-based technology and 5G New Radio (NR)-based technology of the 3rd Generation Partnership Project (3GPP) standard.

Hereinafter, technical features to which examples of the present disclosure may be applied will be described.

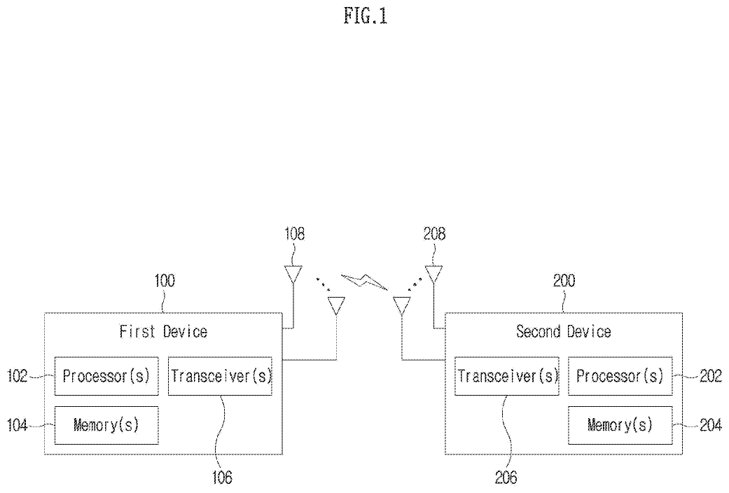

FIG. 1 illustrates a block diagram of a wireless communication device according to an embodiment of the present disclosure.

The first device 100 and the second device 200 illustrated in FIG. 1 may be replaced with various terms such as a terminal, a wireless device, a Wireless Transmit Receive Unit (WTRU), an User Equipment (UE), a Mobile Station (MS), an user terminal (UT), a Mobile Subscriber Station (MSS), a Mobile Subscriber Unit (MSU), a subscriber station (SS), an advanced mobile station (AMS), a wireless terminal (WT), or simply user, etc. In addition, the first device 100 and the second device 200 include an access point (AP), a base station (BS), a fixed station, a Node B, a base transceiver system (BTS), a network, It may be replaced with various terms such as an Artificial Intelligence (AI) system, a road side unit (RSU), a repeater, a router, a relay, and a gateway.

The devices 100 and 200 illustrated in FIG. 1 may be referred to as stations (STAs). For example, the devices 100 and 200 illustrated in FIG. 1 may be referred to by various terms such as a transmitting device, a receiving device, a transmitting STA, and a receiving STA. For example, the STAs 110 and 200 may perform an access point (AP) role or a non-AP role. That is, in the present disclosure, the STAs 110 and 200 may perform functions of an AP and/or a non-AP. When the STAs 110 and 200 perform an AP function, they may be simply referred to as APs, and when the STAs 110 and 200 perform non-AP functions, they may be simply referred to as STAs. In addition, in the present disclosure, an AP may also be indicated as an AP STA.

Referring to FIG. 1, the first device 100 and the second device 200 may transmit and receive radio signals through various wireless LAN technologies (e.g., IEEE 802.11 series). The first device 100 and the second device 200 may include an interface for a medium access control (MAC) layer and a physical layer (PHY) conforming to the IEEE 802.11 standard.

In addition, the first device 100 and the second device 200 may additionally support various communication standards (e.g., 3GPP LTE series, 5G NR series standards, etc.) technologies other than wireless LAN technology. In addition, the device of the present disclosure may be implemented in various devices such as a mobile phone, a vehicle, a personal computer, augmented reality (AR) equipment, and virtual reality (VR) equipment, etc. In addition, the STA of the present specification may support various communication services such as a voice call, a video call, data communication, autonomous-driving, machine-type communication (MTC), machine-to-machine (M2M), device-to-device (D2D), IoT (Internet-of-Things), etc.

A first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including instructions for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless LAN technology (e.g., IEEE 802.11 series). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a device may mean a communication modem/circuit/chip.

A second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including instructions for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless LAN technology (e.g., IEEE 802.11 series). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC). One or more processors 102, 202 may generate one or more PDUs (Protocol Data Unit) and/or one or more SDUs (Service Data Unit) according to description, functions, procedures, proposals, methods and/or operation flow charts disclosed in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, an instruction and/or a set of instructions.

One or more memories 104, 204 may be connected to one or more processors 102, 202 and may store data, a signal, a message, information, a program, a code, an indication and/or an instruction in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

For example, one of the STAs 100 and 200 may perform an intended operation of an AP, and the other of the STAs 100 and 200 may perform an intended operation of a non-AP STA. For example, the transceivers 106 and 206 of FIG. 1 may perform a transmission and reception operation of a signal (e.g., a packet or a physical layer protocol data unit (PPDU) conforming to IEEE 802.11a/b/g/n/ac/ax/be). In addition, in the present disclosure, an operation in which various STAs generate transmission/reception signals or perform data processing or calculation in advance for transmission/reception signals may be performed by the processors 102 and 202 of FIG. 1. For example, an example of an operation of generating a transmission/reception signal or performing data processing or calculation in advance for the transmission/reception signal may include 1) Determining/acquiring/configuring/calculating/decoding/encoding bit information of fields (signal (SIG), short training field (STF), long training field (LTF), Data, etc.) included in the PPDU, 2) Determining/configuring/acquiring time resources or frequency resources (e.g., subcarrier resources) used for fields (SIG, STF, LTF, Data, etc.) included in the PPDU; 3) Determining/configuring/acquiring a specific sequence (e.g., pilot sequence, STF/LTF sequence, extra sequence applied to SIG) used for fields (SIG, STF, LTF, Data, etc.) included in the PPDU action, 4) power control operation and/or power saving operation applied to the STA, 5) Operations related to ACK signal determination/acquisition/configuration/calculation/decoding/encoding, etc. In addition, in the following example, various information (e.g., information related to fields/subfields/control fields/parameters/power, etc.) used by various STAs to determine/acquire/configure/calculate/decode/encode transmission and reception signals may be stored in the memories 104 and 204 of FIG. 1.

Hereinafter, downlink (DL) may mean a link for communication from an AP STA to a non-AP STA, and a DL PPDU/packet/signal may be transmitted and received through the DL. In DL communication, a transmitter may be part of an AP STA, and a receiver may be part of a non-AP STA. Uplink (UL) may mean a link for communication from non-AP STAs to AP STAs, and a UL PPDU/packet/signal may be transmitted and received through the UL. In UL communication, a transmitter may be part of a non-AP STA, and a receiver may be part of an AP STA.

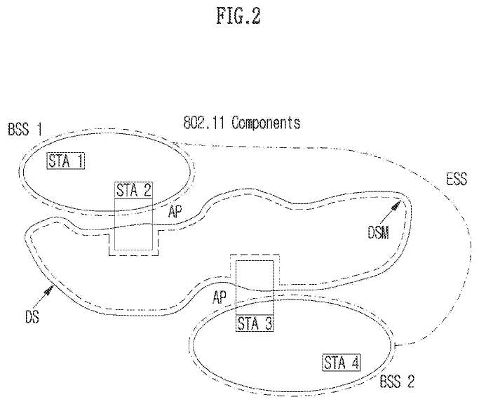

FIG. 2 is a diagram illustrating an exemplary structure of a wireless LAN system to which the present disclosure may be applied.

The structure of the wireless LAN system may consist of be composed of a plurality of components. A wireless LAN supporting STA mobility transparent to an upper layer may be provided by interaction of a plurality of components. A Basic Service Set (BSS) corresponds to a basic construction block of a wireless LAN. FIG. 2 exemplarily shows that two BSSs (BSS1 and BSS2) exist and two STAs are included as members of each BSS (STA1 and STA2 are included in BSS1, and STA3 and STA4 are included in BSS2). An ellipse representing a BSS in FIG. 2 may also be understood as representing a coverage area in which STAs included in the corresponding BSS maintain communication. This area may be referred to as a Basic Service Area (BSA). When an STA moves out of the BSA, it may not directly communicate with other STAs within the BSA.

If the DS shown in FIG. 2 is not considered, the most basic type of BSS in a wireless LAN is an independent BSS (IBSS). For example, IBSS may have a minimal form containing only two STAs. For example, assuming that other components are omitted, BSS1 containing only STA1 and STA2 or BSS2 containing only STA3 and STA4 may respectively correspond to representative examples of IBSS. This configuration is possible when STAs may communicate directly without an AP. In addition, in this type of wireless LAN, it is not configured in advance, but may be configured when a LAN is required, and this may be referred to as an ad-hoc network. Since the IBSS does not include an AP, there is no centralized management entity. That is, in IBSS, STAs are managed in a distributed manner. In IBSS, all STAs may be made up of mobile STAs, and access to the distributed system (DS) is not allowed, forming a self-contained network.

Membership of an STA in the BSS may be dynamically changed by turning on or off the STA, entering or exiting the BSS area, and the like. To become a member of the BSS, the STA may join the BSS using a synchronization process. In order to access all services of the BSS infrastructure, the STA shall be associated with the BSS. This association may be dynamically established and may include the use of a Distribution System Service (DSS).

A direct STA-to-STA distance in a wireless LAN may be limited by PHY performance. In some cases, this distance limit may be sufficient, but in some cases, communication between STAs at a longer distance may be required. A distributed system (DS) may be configured to support extended coverage.

DS means a structure in which BSSs are interconnected. Specifically, as shown in FIG. 2, a BSS may exist as an extended form of a network composed of a plurality of BSSs. DS is a logical concept and may be specified by the characteristics of Distributed System Media (DSM). In this regard, a wireless medium (WM) and a DSM may be logically separated. Each logical medium is used for a different purpose and is used by different components. These medium are not limited to being the same, nor are they limited to being different. In this way, the flexibility of the wireless LAN structure (DS structure or other network structure) may be explained in that a plurality of media are logically different. That is, the wireless LAN structure may be implemented in various ways, and the corresponding wireless LAN structure may be independently specified by the physical characteristics of each embodiment.

A DS may support a mobile device by providing seamless integration of a plurality of BSSs and providing logical services necessary to address an address to a destination. In addition, the DS may further include a component called a portal that serves as a bridge for connection between the wireless LAN and other networks (e.g., IEEE 802.X).

The AP enables access to the DS through the WM for the associated non-AP STAs, and means an entity that also has the functionality of an STA. Data movement between the BSS and the DS may be performed through the AP. For example, STA2 and STA3 shown in FIG. 2 have the functionality of STAs, and provide a function allowing the associated non-AP STAs (STA1 and STA4) to access the DS. In addition, since all APs basically correspond to STAs, all APs are addressable entities. The address used by the AP for communication on the WM and the address used by the AP for communication on the DSM are not necessarily the same. A BSS composed of an AP and one or more STAs may be referred to as an infrastructure BSS.

Data transmitted from one of the STA(s) associated with an AP to a STA address of the corresponding AP may be always received on an uncontrolled port and may be processed by an IEEE 802.1X port access entity. In addition, when a controlled port is authenticated, transmission data (or frames) may be delivered to the DS.

In addition to the structure of the DS described above, an extended service set (ESS) may be configured to provide wide coverage.

An ESS means a network in which a network having an arbitrary size and complexity is composed of DSs and BSSs. The ESS may correspond to a set of BSSs connected to one DS. However, the ESS does not include the DS. An ESS network is characterized by being seen as an IBSS in the Logical Link Control (LLC) layer. STAs included in the ESS may communicate with each other, and mobile STAs may move from one BSS to another BSS (within the same ESS) transparently to the LLC. APs included in one ESS may have the same service set identification (SSID). The SSID is distinguished from the BSSID, which is an identifier of the BSS.

The wireless LAN system does not assume anything about the relative physical locations of BSSs, and all of the following forms are possible. BSSs may partially overlap, which is a form commonly used to provide continuous coverage. In addition, BSSs may not be physically connected, and logically there is no limit on the distance between BSSs. In addition, the BSSs may be physically located in the same location, which may be used to provide redundancy. In addition, one (or more than one) IBSS or ESS networks may physically exist in the same space as one (or more than one) ESS network. When an ad-hoc network operates in a location where an ESS network exists, when physically overlapping wireless networks are configured by different organizations, or when two or more different access and security policies are required in the same location, this may correspond to the form of an ESS network in the like.

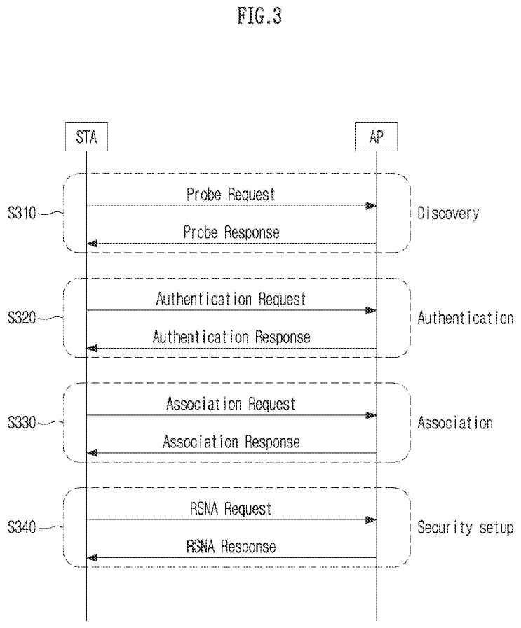

FIG. 3 is a diagram for explaining a link setup process to which the present disclosure may be applied.

In order for an STA to set up a link with respect to a network and transmit/receive data, it first discovers a network, performs authentication, establishes an association, and need to perform the authentication process for security. The link setup process may also be referred to as a session initiation process or a session setup process. In addition, the processes of discovery, authentication, association, and security setting of the link setup process may be collectively referred to as an association process.

In step S310, the STA may perform a network discovery operation. The network discovery operation may include a scanning operation of the STA. That is, in order for the STA to access the network, it needs to find a network in which it can participate. The STA shall identify a compatible network before participating in a wireless network, and the process of identifying a network existing in a specific area is called scanning.

Scanning schemes include active scanning and passive scanning. FIG. 3 exemplarily illustrates a network discovery operation including an active scanning process. In active scanning, an STA performing scanning transmits a probe request frame to discover which APs exist around it while moving channels and waits for a response thereto. A responder transmits a probe response frame as a response to the probe request frame to the STA that has transmitted the probe request frame. Here, the responder may be an STA that last transmitted a beacon frame in the BSS of the channel being scanned. In the BSS, since the AP transmits the beacon frame, the AP becomes a responder, and in the IBSS, the STAs in the IBSS rotate to transmit the beacon frame, so the responder is not constant. For example, a STA that transmits a probe request frame on channel 1 and receives a probe response frame on channel 1, may store BSS-related information included in the received probe response frame and may move to the next channel (e.g., channel 2) and perform scanning (i.e., transmission/reception of a probe request/response on channel 2) in the same manner.

Although not shown in FIG. 3, the scanning operation may be performed in a passive scanning manner. In passive scanning, a STA performing scanning waits for a beacon frame while moving channels. The beacon frame is one of the management frames defined in IEEE 802.11, and is periodically transmitted to notify the existence of a wireless network and to allow the STA performing scanning to find a wireless network and participate in the wireless network. In the BSS, the AP serves to transmit beacon frames periodically, and in the IBSS, STAs within the IBSS rotate to transmit beacon frames. When the STA performing scanning receives a beacon frame, the STA stores information for the BSS included in the beacon frame and records beacon frame information in each channel while moving to another channel. The STA receiving the beacon frame may store BSS-related information included in the received beacon frame, move to the next channel, and perform scanning in the next channel in the same way. Comparing active scanning and passive scanning, active scanning has an advantage of having less delay and less power consumption than passive scanning.

After the STA discovers the network, an authentication process may be performed in step S320. This authentication process may be referred to as a first authentication process in order to be clearly distinguished from the security setup operation of step S340 to be described later.

The authentication process includes a process in which the STA transmits an authentication request frame to the AP, and in response to this, the AP transmits an authentication response frame to the STA. An authentication frame used for authentication request/response corresponds to a management frame.

The authentication frame includes an authentication algorithm number, an authentication transaction sequence number, a status code, a challenge text, a robust security network (RSN), and a Finite Cyclic Group, etc. This corresponds to some examples of information that may be included in the authentication request/response frame, and may be replaced with other information or additional information may be further included.

The STA may transmit an authentication request frame to the AP. The AP may determine whether to allow authentication of the corresponding STA based on information included in the received authentication request frame. The AP may provide the result of the authentication process to the STA through an authentication response frame.

After the STA is successfully authenticated, an association process may be performed in step S330. The association process includes a process in which the STA transmits an association request frame to the AP, and in response, the AP transmits an association response frame to the STA.

For example, the association request frame may include information related to various capabilities, a beacon listen interval, a service set identifier (SSID), supported rates, supported channels, RSN, mobility domain, supported operating classes, Traffic Indication Map Broadcast request (TIM broadcast request), interworking service capability, etc. For example, the association response frame may include information related to various capabilities, status code, association ID (AID), supported rates, enhanced distributed channel access (EDCA) parameter set, received channel power indicator (RCPI), received signal to noise indicator (RSNI), mobility domain, timeout interval (e.g., association comeback time), overlapping BSS scan parameters, TIM broadcast response, Quality of Service (QoS) map, etc. This corresponds to some examples of information that may be included in the association request/response frame, and may be replaced with other information or additional information may be further included.

After the STA is successfully associated with the network, a security setup process may be performed in step S340. The security setup process of step S340 may be referred to as an authentication process through Robust Security Network Association (RSNA) request/response, and the authentication process of step S320 is referred to as a first authentication process, and the security setup process of step S340 may also simply be referred to as an authentication process.

The security setup process of step S340 may include, for example, a process of setting up a private key through 4-way handshaking through an Extensible Authentication Protocol over LAN (EAPOL) frame. In addition, the security setup process may be performed according to a security scheme not defined in the IEEE 802.11 standard.

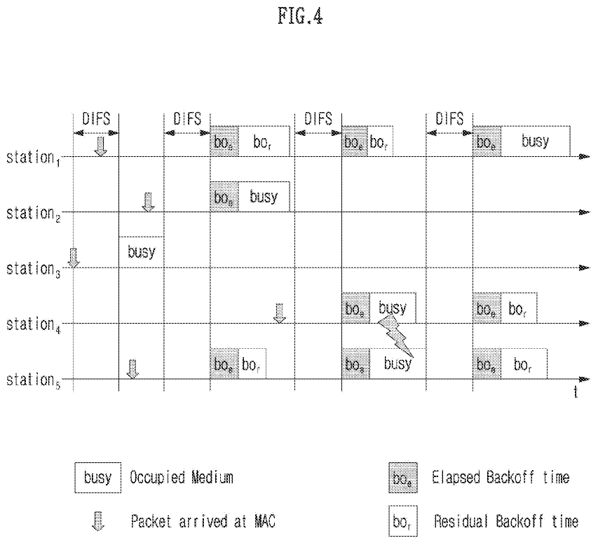

FIG. 4 is a diagram for explaining a backoff process to which the present disclosure may be applied.

In the wireless LAN system, a basic access mechanism of medium access control (MAC) is a carrier sense multiple access with collision avoidance (CSMA/CA) mechanism. The CSMA/CA mechanism is also called Distributed Coordination Function (DCF) of IEEE 802.11 MAC, and basically adopts a “listen before talk” access mechanism. According to this type of access mechanism, the AP and/or STA may perform Clear Channel Assessment (CCA) sensing a radio channel or medium during a predetermined time interval (e.g., DCF Inter-Frame Space (DIFS)), prior to starting transmission. As a result of the sensing, if it is determined that the medium is in an idle state, frame transmission is started through the corresponding medium. On the other hand, if it is detected that the medium is occupied or busy, the corresponding AP and/or STA does not start its own transmission and may set a delay period for medium access (e.g., a random backoff period) and attempt frame transmission after waiting. By applying the random backoff period, since it is expected that several STAs attempt frame transmission after waiting for different periods of time, collision may be minimized.

In addition, the IEEE 802.11 MAC protocol provides a Hybrid Coordination Function (HCF). HCF is based on the DCF and Point Coordination Function (PCF). PCF is a polling-based synchronous access method and refers to a method in which all receiving APs and/or STAs periodically poll to receive data frames. In addition, HCF has Enhanced Distributed Channel Access (EDCA) and HCF Controlled Channel Access (HCCA). EDCA is a contention-based access method for a provider to provide data frames to multiple users, and HCCA uses a non-contention-based channel access method using a polling mechanism. In addition, the HCF includes a medium access mechanism for improving QoS (Quality of Service) of the wireless LAN, and may transmit QoS data in both a Contention Period (CP) and a Contention Free Period (CFP).

Referring to FIG. 4, an operation based on a random backoff period will be described. When the occupied/busy medium changes to an idle state, several STAs may attempt to transmit data (or frames). As a method for minimizing collisions, each of STAs may respectively select a random backoff count and attempt transmission after waiting for a corresponding slot time. The random backoff count has a pseudo-random integer value and may be determined as one of values ranging from 0 to CW. Here, CW is a contention window parameter value. The CW parameter is given CWmin as an initial value, but may take a value twice as large in case of transmission failure (e.g., when an ACK for the transmitted frame is not received). When the CW parameter value reaches CWmax, data transmission may be attempted while maintaining the CWmax value until data transmission is successful, and when data transmission is successful, the CWmin value is reset. The values of CW, CWmin and CWmax are preferably set to 2n−1 (n=0, 1, 2, . . . ).

When the random backoff process starts, the STA continuously monitors the medium while counting down the backoff slots according to the determined backoff count value. When the medium is monitored for occupancy, it stops counting down and waits, and resumes the rest of the countdown when the medium becomes idle.

In the example of FIG. 4, when a packet to be transmitted arrives at the MAC of STA3, STA3 may transmit the frame immediately after confirming that the medium is idle as much as DIFS. The remaining STAs monitor and wait for the medium to be occupied/busy. In the meantime, data to be transmitted may also occur in each of STA1, STA2, and STA5, and each STA waits as long as DIFS when the medium is monitored as idle, and then may perform a countdown of the backoff slot according to the random backoff count value selected by each STA. Assume that STA2 selects the smallest backoff count value and STA1 selects the largest backoff count value. That is, the case where the remaining back-off time of STA5 is shorter than the remaining back-off time of STA1 at the time when STA2 completes the back-off count and starts frame transmission is exemplified. STA1 and STA5 temporarily stop counting down and wait while STA2 occupies the medium. When the occupation of STA2 ends and the medium becomes idle again, STA1 and STA5 wait for DIFS and resume the stopped backoff count. That is, frame transmission may be started after counting down the remaining backoff slots for the remaining backoff time. Since the remaining backoff time of STA5 is shorter than that of STA1, STA5 starts frame transmission. While STA2 occupies the medium, data to be transmitted may also occur in STA4. From the standpoint of STA4, when the medium becomes idle, STA4 may wait for DIFS, and then may perform a countdown according to the random backoff count value selected by the STA4 and start transmitting frames. The example of FIG. 4 shows a case where the remaining backoff time of STA5 coincides with the random backoff count value of STA4 by chance. In this case, a collision may occur between STA4 and STA5. When a collision occurs, both STA4 and STA5 do not receive an ACK, so data transmission fails. In this case, STA4 and STA5 may double the CW value, select a random backoff count value, and perform a countdown. STA1 waits while the medium is occupied due to transmission of STA4 and STA5, waits for DIFS when the medium becomes idle, and then starts frame transmission after the remaining backoff time has elapsed.

As in the example of FIG. 4, the data frame is a frame used for transmission of data forwarded to a higher layer, and may be transmitted after a backoff performed after DIFS elapses from when the medium becomes idle. Additionally, the management frame is a frame used for exchange of management information that is not forwarded to a higher layer, and is transmitted after a backoff performed after an IFS such as DIFS or Point Coordination Function IFS (PIFS). As a subtype frames of management frame, there are a Beacon, an association request/response, a re-association request/response, a probe request/response, an authentication request/response, etc. A control frame is a frame used to control access to a medium. As a subtype frames of control frame, there are Request-To-Send (RTS), Clear-To-Send (CTS), Acknowledgement (ACK), Power Save-Poll (PS-Poll), block ACK (BlockAck), block ACK request (BlockACKReq), null data packet announcement (NDP announcement), and trigger, etc. If the control frame is not a response frame of the previous frame, it is transmitted after backoff performed after DIFS elapses, and if it is a response frame of the previous frame, it is transmitted without performing backoff after short IFS (SIFS) elapses. The type and subtype of the frame may be identified by a type field and a subtype field in a frame control (FC) field.

A Quality of Service (QoS) STA may perform the backoff that is performed after an arbitration IFS (AIFS) for an access category (AC) to which the frame belongs, that is, AIFS[i] (where i is a value determined by AC), and then may transmit the frame. Here, the frame in which AIFS[i] can be used may be a data frame, a management frame, or a control frame other than a response frame.

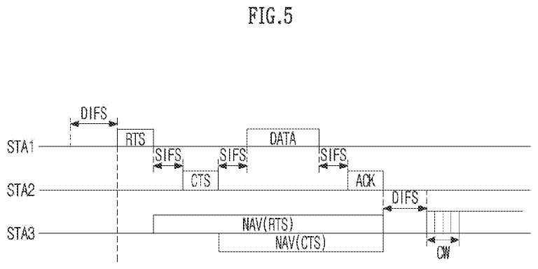

FIG. 5 is a diagram for explaining a frame transmission operation based on CSMA/CA to which the present disclosure may be applied.

As described above, the CSMA/CA mechanism includes virtual carrier sensing in addition to physical carrier sensing in which a STA directly senses a medium. Virtual carrier sensing is intended to compensate for problems that may occur in medium access, such as a hidden node problem. For virtual carrier sensing, the MAC of the STA may use a Network Allocation Vector (NAV). The NAV is a value indicating, to other STAs, the remaining time until the medium is available for use by an STA currently using or having the right to use the medium. Therefore, the value set as NAV corresponds to a period in which the medium is scheduled to be used by the STA transmitting the frame, and the STA receiving the NAV value is prohibited from accessing the medium during the corresponding period. For example, the NAV may be configured based on the value of the “duration” field of the MAC header of the frame.

In the example of FIG. 5, it is assumed that a STA1 intends to transmit data to a STA2, and a STA3 is in a position capable of overhearing some or all of frames transmitted and received between the STA1 and the STA2.

In order to reduce the possibility of collision of transmissions of multiple STAs in CSMA/CA based frame transmission operation, a mechanism using RTS/CTS frames may be applied. In the example of FIG. 5, while transmission of the STA1 is being performed, as a result of carrier sensing of the STA3, it may be determined that the medium is in an idle state. That is, the STA1 may correspond to a hidden node to the STA3. Alternatively, in the example of FIG. 5, it may be determined that the carrier sensing result medium of the STA3 is in an idle state while transmission of the STA2 is being performed. That is, the STA2 may correspond to a hidden node to the STA3. Through the exchange of RTS/CTS frames before performing data transmission and reception between the STA1 and the STA2, a STA outside the transmission range of one of the STA1 or the STA2, or a STA outside the carrier sensing range for transmission from the STA1 or the STA3 may not attempt to occupy the channel during data transmission and reception between the STA1 and the STA2.

Specifically, the STA1 may determine whether a channel is being used through carrier sensing. In terms of physical carrier sensing, the STA1 may determine a channel occupation idle state based on an energy level or signal correlation detected in a channel. In addition, in terms of virtual carrier sensing, the STA1 may determine a channel occupancy state using a network allocation vector (NAV) timer.

The STA1 may transmit an RTS frame to the STA2 after performing a backoff when the channel is in an idle state during DIFS. When the STA2 receives the RTS frame, the STA2 may transmit a CTS frame as a response to the RTS frame to the STA1 after SIFS.

If the STA3 cannot overhear the CTS frame from the STA2 but can overhear the RTS frame from the STA1, the STA3 may set a NAV timer for a frame transmission period (e.g., SIFS+CTS frame+SIFS+data frame+SIFS+ACK frame) that is continuously transmitted thereafter, using the duration information included in the RTS frame. Alternatively, if the STA3 can overhear a CTS frame from the STA2 although the STA3 cannot overhear an RTS frame from the STA1, the STA3 may set a NAV timer for a frame transmission period (e.g., SIFS+data frame+SIFS+ACK frame) that is continuously transmitted thereafter, using the duration information included in the CTS frame. That is, if the STA3 can overhear one or more of the RTS or CTS frames from one or more of the STA1 or the STA2, the STA3 may set the NAV accordingly. When the STA3 receives a new frame before the NAV timer expires, the STA3 may update the NAV timer using duration information included in the new frame. The STA3 does not attempt channel access until the NAV timer expires.

When the STA1 receives the CTS frame from the STA2, the STA1 may transmit the data frame to the STA2 after SIFS from the time point when the reception of the CTS frame is completed. When the STA2 successfully receives the data frame, the STA2 may transmit an ACK frame as a response to the data frame to the STA1 after SIFS. The STA3 may determine whether the channel is being used through carrier sensing when the NAV timer expires. When the STA3 determines that the channel is not used by other terminals during DIFS after expiration of the NAV timer, the STA3 may attempt channel access after a contention window (CW) according to a random backoff has passed.

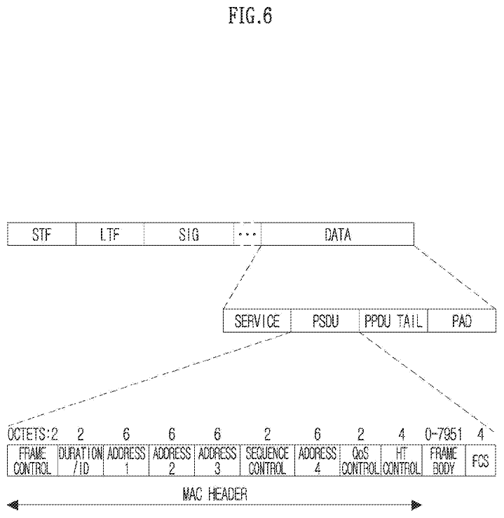

FIG. 6 is a diagram for explaining an example of a frame structure used in a WLAN system to which the present disclosure may be applied.

By means of an instruction or primitive (meaning a set of instructions or parameters) from the MAC layer, the PHY layer may prepare a MAC PDU (MPDU) to be transmitted. For example, when a command requesting transmission start of the PHY layer is received from the MAC layer, the PHY layer switches to the transmission mode and configures information (e.g., data) provided from the MAC layer in the form of a frame and transmits it. In addition, when the PHY layer detects a valid preamble of the received frame, the PHY layer monitors the header of the preamble and sends a command notifying the start of reception of the PHY layer to the MAC layer.

In this way, information transmission/reception in a wireless LAN system is performed in the form of a frame, and for this purpose, a PHY layer protocol data unit (PPDU) frame format is defined.

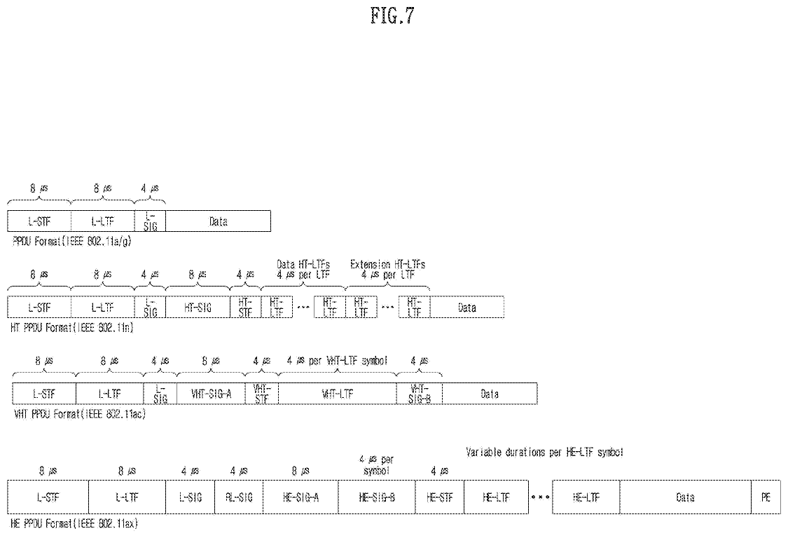

A basic PPDU frame may include a Short Training Field (STF), a Long Training Field (LTF), a SIGNAL (SIG) field, and a Data field. The most basic (e.g., non-High Throughput (HT)) PPDU frame format may consist of only L-STF (Legacy-STF), L-LTF (Legacy-LTF), SIG field, and data field. In addition, depending on the type of PPDU frame format (e.g., HT-mixed format PPDU, HT-greenfield format PPDU, VHT (Very High Throughput) PPDU, etc.), an additional (or different type) STF, LTF, and SIG fields may be included between the SIG field and the data field (this will be described later with reference to FIG. 7).

The STF is a signal for signal detection, automatic gain control (AGC), diversity selection, precise time synchronization, and the like, and the LTF is a signal for channel estimation and frequency error estimation. The STF and LTF may be referred to as signals for synchronization and channel estimation of the OFDM physical layer.

The SIG field may include a RATE field and a LENGTH field. The RATE field may include information on modulation and coding rates of data. The LENGTH field may include information on the length of data. Additionally, the SIG field may include a parity bit, a SIG TAIL bit, and the like.

The data field may include a SERVICE field, a physical layer service data unit (PSDU), and a PPDU TAIL bit, and may also include padding bits if necessary. Some bits of the SERVICE field may be used for synchronization of the descrambler at the receiving end. The PSDU corresponds to the MAC PDU defined in the MAC layer, and may include data generated/used in the upper layer. The PPDU TAIL bit may be used to return the encoder to a 0 state. Padding bits may be used to adjust the length of a data field in a predetermined unit.

A MAC PDU is defined according to various MAC frame formats, and a basic MAC frame consists of a MAC header, a frame body, and a Frame Check Sequence (FCS). The MAC frame may consist of MAC PDUs and be transmitted/received through the PSDU of the data part of the PPDU frame format.

The MAC header includes a Frame Control field, a Duration/ID field, an Address field, and the like. The frame control field may include control information required for frame transmission/reception. The duration/ID field may be set to a time for transmitting a corresponding frame or the like. For details of the Sequence Control, QoS Control, and HT Control subfields of the MAC header, refer to the IEEE 802.11 standard document.

A null-data packet (NDP) frame format means a frame format that does not include a data packet. That is, the NDP frame refers to a frame format that includes a physical layer convergence procedure (PLCP) header part (i.e., STF, LTF, and SIG fields) in a general PPDU frame format and does not include the remaining parts (i.e., data field). A NDP frame may also be referred to as a short frame format.

FIG. 7 is a diagram illustrating examples of PPDUs defined in the IEEE 802.11 standard to which the present disclosure may be applied.

In standards such as IEEE 802.11a/g/n/ac/ax, various types of PPDUs have been used. The basic PPDU format (IEEE 802.11a/g) includes L-LTF, L-STF, L-SIG and Data fields. The basic PPDU format may also be referred to as a non-HT PPDU format.

The HT PPDU format (IEEE 802.11n) additionally includes HT-SIG, HT-STF, and HT-LFT(s) fields to the basic PPDU format. The HT PPDU format shown in FIG. 7 may be referred to as an HT-mixed format. In addition, an HT-greenfield format PPDU may be defined, and this corresponds to a format consisting of HT-GF-STF, HT-LTF1, HT-SIG, one or more HT-LTF, and Data field, not including L-STF, L-LTF, and L-SIG (not shown).

An example of the VHT PPDU format (IEEE 802.11ac) additionally includes VHT SIG-A, VHT-STF, VHT-LTF, and VHT-SIG-B fields to the basic PPDU format.

An example of the HE PPDU format (IEEE 802.11ax) additionally includes Repeated L-SIG (RL-SIG), HE-SIG-A, HE-SIG-B, HE-STF, HE-LTF(s), Packet Extension (PE) field to the basic PPDU format. Some fields may be excluded or their length may vary according to detailed examples of the HE PPDU format. For example, the HE-SIG-B field is included in the HE PPDU format for multi-user (MU), and the HE-SIG-B is not included in the HE PPDU format for single user (SU). In addition, the HE trigger-based (TB) PPDU format does not include the HE-SIG-B, and the length of the HE-STF field may vary to 8 us. The Extended Range (HE ER) SU PPDU format does not include the HE-SIG-B field, and the length of the HE-SIG-A field may vary to 16 us.

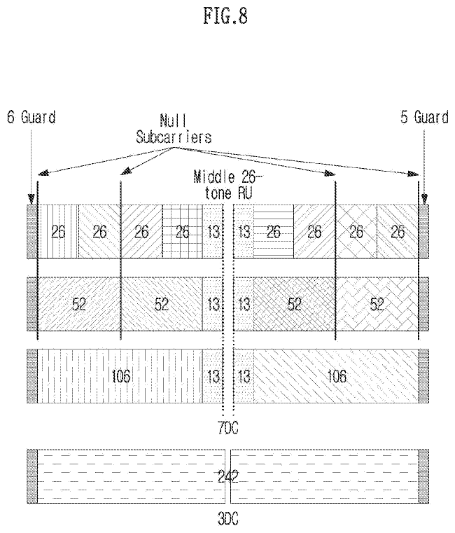

FIGS. 8 to 10 are diagrams for explaining examples of resource units of a WLAN system to which the present disclosure may be applied.

Referring to FIGS. 8 to 10, a resource unit (RU) defined in a wireless LAN system will be described. the RU may include a plurality of subcarriers (or tones). The RU may be used when transmitting signals to multiple STAs based on the OFDMA scheme. In addition, the RU may be defined even when a signal is transmitted to one STA. The RU may be used for STF, LTF, data field of the PPDU, etc.

As shown in FIGS. 8 to 10, RUs corresponding to different numbers of tones (i.e., subcarriers) are used to construct some fields of 20 MHz, 40 MHz, or 80 MHz X-PPDUs (X is HE, EHT, etc.). For example, resources may be allocated in RU units shown for the X-STF, X-LTF, and Data field.

FIG. 8 is a diagram illustrating an exemplary allocation of resource units (RUs) used on a 20 MHz band.

As shown at the top of FIG. 8, 26-units (i.e., units corresponding to 26 tones) may be allocated. 6 tones may be used as a guard band in the leftmost band of the 20 MHz band, and 5 tones may be used as a guard band in the rightmost band of the 20 MHz band. In addition, 7 DC tones are inserted in the center band, that is, the DC band, and 26-units corresponding to each of the 13 tones may exist on the left and right sides of the DC band. In addition, 26-unit, 52-unit, and 106-unit may be allocated to other bands. Each unit may be allocated for STAs or users.

The RU allocation of FIG. 8 is utilized not only in a situation for multiple users (MU) but also in a situation for a single user (SU), and in this case, it is possible to use one 242-unit as shown at the bottom of FIG. 8. In this case, three DC tones may be inserted.

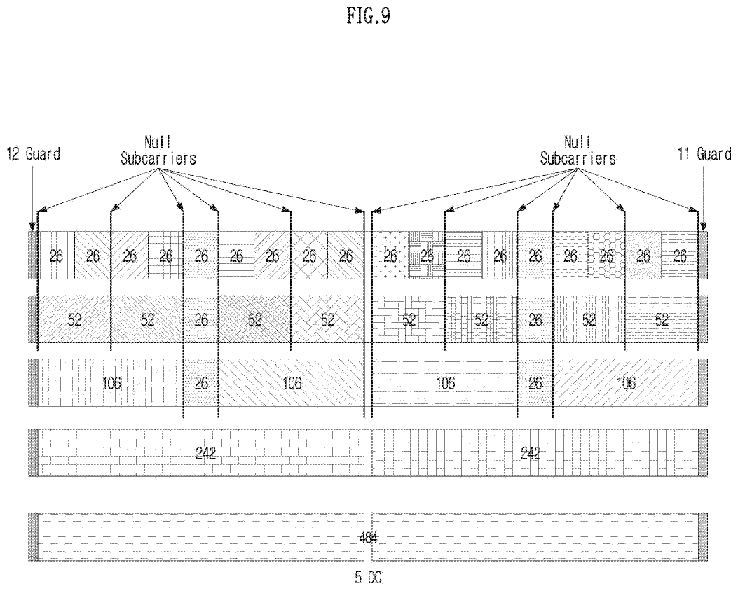

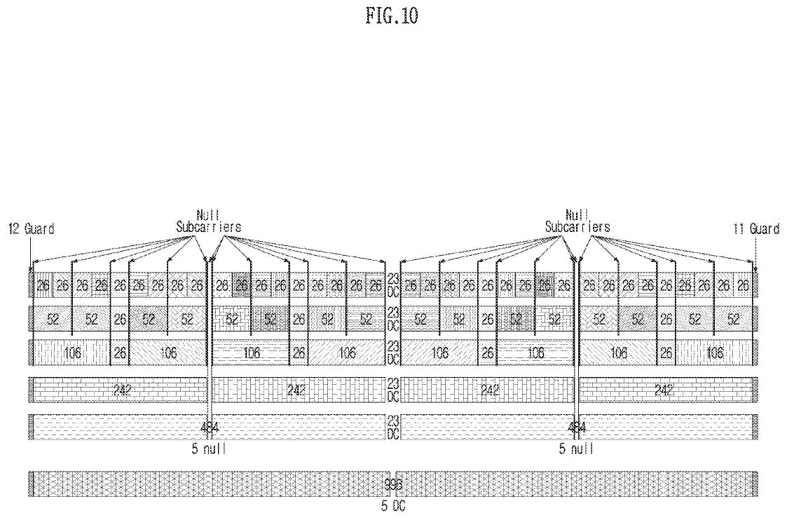

In the example of FIG. 8, RUs of various sizes, that is, 26-RU, 52-RU, 106-RU, 242-RU, etc. are exemplified, but the specific size of these RUs may be reduced or expanded. Therefore, in the present disclosure, the specific size of each RU (i.e., the number of corresponding tones) is exemplary and not restrictive. In addition, within a predetermined bandwidth (e.g., 20, 40, 80, 160, 320 MHz, . . . ) in the present disclosure, the number of RUs may vary according to the size of the RU. In the examples of FIG. 9 and/or FIG. 10 to be described below, the fact that the size and/or number of RUs may be varied is the same as the example of FIG. 8.

FIG. 9 is a diagram illustrating an exemplary allocation of resource units (RUs) used on a 40 MHz band.

Just as RUs of various sizes are used in the example of FIG. 8, 26-RU, 52-RU, 106-RU, 242-RU, 484-RU, and the like may be used in the example of FIG. 9 as well. In addition, 5 DC tones may be inserted at the center frequency, 12 tones may be used as a guard band in the leftmost band of the 40 MHz band, and 11 tones may be used as a guard band in the rightmost band of the 40 MHz band.

In addition, as shown, when used for a single user, a 484-RU may be used.

FIG. 10 is a diagram illustrating an exemplary allocation of resource units (RUs) used on an 80 MHz band.

Just as RUs of various sizes are used in the example of FIG. 8 and FIG. 9, 26-RU, 52-RU, 106-RU, 242-RU, 484-RU, 996-RU and the like may be used in the example of FIG. 10 as well. In addition, in the case of an 80 MHz PPDU, RU allocation of HE PPDUs and EHT PPDUs may be different, and the example of FIG. 10 shows an example of RU allocation for 80 MHz EHT PPDUs. The scheme that 12 tones are used as a guard band in the leftmost band of the 80 MHz band and 11 tones are used as a guard band in the rightmost band of the 80 MHz band in the example of FIG. 10 is the same in HE PPDU and EHT PPDU. Unlike HE PPDU, where 7 DC tones are inserted in the DC band and there is one 26-RU corresponding to each of the 13 tones on the left and right sides of the DC band, in the EHT PPDU, 23 DC tones are inserted into the DC band, and one 26-RU exists on the left and right sides of the DC band. Unlike the HE PPDU, where one null subcarrier exists between 242-RUs rather than the center band, there are five null subcarriers in the EHT PPDU. In the HE PPDU, one 484-RU does not include null subcarriers, but in the EHT PPDU, one 484-RU includes 5 null subcarriers.

In addition, as shown, when used for a single user, 996-RU may be used, and in this case, 5 DC tones are inserted in common with HE PPDU and EHT PPDU.

EHT PPDUs over 160 MHz may be configured with a plurality of 80 MHz subblocks in FIG. 10. The RU allocation for each 80 MHz subblock may be the same as that of the 80 MHz EHT PPDU of FIG. 10. If the 80 MHz subblock of the 160 MHz or 320 MHz EHT PPDU is not punctured and the entire 80 MHz subblock is used as part of RU or multiple RU (MRU), the 80 MHz subblock may use 996-RU of FIG. 10.

Here, the MRU corresponds to a group of subcarriers (or tones) composed of a plurality of RUs, and the plurality of RUs constituting the MRU may be RUs having the same size or RUs having different sizes. For example, a single MRU may be defined as 52+26-tone, 106+26-tone, 484+242-tone, 996+484-tone, 996+484+242-tone, 2×996+484-tone, 3×996-tone, or 3×996+484-tone. Here, the plurality of RUs constituting one MRU may correspond to small size (e.g., 26, 52, or 106) RUs or large size (e.g., 242, 484, or 996) RUs. That is, one MRU including a small size RU and a large size RU may not be configured/defined. In addition, a plurality of RUs constituting one MRU may or may not be consecutive in the frequency domain.

When an 80 MHz subblock includes RUs smaller than 996 tones, or parts of the 80 MHz subblock are punctured, the 80 MHz subblock may use RU allocation other than the 996-tone RU.

The RU of the present disclosure may be used for uplink (UL) and/or downlink (DL) communication. For example, when trigger-based UL-MU communication is performed, the STA transmitting the trigger (e.g., AP) may allocate a first RU (e.g., 26/52/106/242-RU, etc.) to a first STA and allocate a second RU (e.g., 26/52/106/242-RU, etc.) to a second STA, through trigger information (e.g., trigger frame or triggered response scheduling (TRS)). Thereafter, the first STA may transmit a first trigger-based (TB) PPDU based on the first RU, and the second STA may transmit a second TB PPDU based on the second RU. The first/second TB PPDUs may be transmitted to the AP in the same time period.

For example, when a DL MU PPDU is configured, the STA transmitting the DL MU PPDU (e.g., AP) may allocate a first RU (e.g., 26/52/106/242-RU, etc.) to a first STA and allocate a second RU (e.g., 26/52/106/242-RU, etc.) to a second STA. That is, the transmitting STA (e.g., AP) may transmit HE-STF, HE-LTF, and Data field for the first STA through the first RU and transmit HE-STF, HE-LTF, and Data field for the second STA through the second RU, in one MU PPDU,

Information on the allocation of RUs may be signaled through HE-SIG-B in the HE PPDU format.

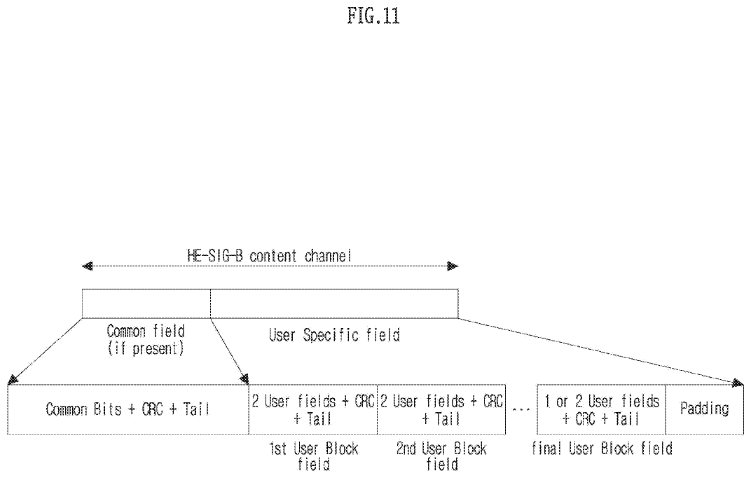

FIG. 11 illustrates an example structure of a HE-SIG-B field.

As shown, the HE-SIG-B field may include a common field and a user-specific field. If HE-SIG-B compression is 5.2 applied (e.g., full-bandwidth MU-MIMO transmission), the common field may not be included in HE-SIG-B, and the HE-SIG-B content channel may include only a user-specific field. If HE-SIG-B compression is not applied, the common field may be included in HE-SIG-B.

The common field may include information on RU allocation (e.g., RU assignment, RUs allocated for MU-MIMO, the number of MU-MIMO users (STAs), etc.)

The common field may include N*8 RU allocation subfields. Here, N is the number of subfields, N=1 in the case of 20 or 40 MHz MU PPDU, N=2 in the case of 80 MHz MU PPDU, N=4 in the case of 160 MHz or 80+80 MHz MU PPDU, etc. One 8-bit RU allocation subfield may indicate the size (26, 52, 106, etc.) and frequency location (or RU index) of RUs included in the 20 MHz band.

For example, if a value of the 8-bit RU allocation subfield is 00000000, it may indicate that nine 26-RUs are sequentially allocated in order from the leftmost to the rightmost in the example of FIG. 8, if the value is 00000001, it may indicate that seven 26-RUs and one 52-RU are sequentially allocated in order from leftmost to rightest, and if the value is 00000010, it may indicate that five 26-RUs, one 52-RU, and two 26-RUs are sequentially allocated from the leftmost side to the rightmost side.

As an additional example, if the value of the 8-bit RU allocation subfield is 001000y2y1y0, it may indicate that one 106-RU and five 26-RUs are sequentially allocated from the leftmost to the rightmost in the example of FIG. 8. In this case, multiple users/STAs may be allocated to the 106-RU in the MU-MIMO scheme. Specifically, up to 8 users/STAs may be allocated to the 106-RU, and the number of users/STAs allocated to the 106-RU is determined based on 3-bit information (i.e., y2y1y0). For example, when the 3-bit information (y2y1y0) corresponds to a decimal value N, the number of users/STAs allocated to the 106-RU may be N+1.

Basically, one user/STA may be allocated to each of a plurality of RUs, and different users/STAs may be allocated to different RUs. For RUs larger than a predetermined size (e.g., 106, 242, 484, 996-tones, . . . ), a plurality of users/STAs may be allocated to one RU, and MU-MIMO scheme may be applied for the plurality of users/STAs.

The set of user-specific fields includes information on how all users (STAs) of the corresponding PPDU decode their payloads. User-specific fields may contain zero or more user block fields. The non-final user block field includes two user fields (i.e., information to be used for decoding in two STAs). The final user block field contains one or two user fields. The number of user fields may be indicated by the RU allocation subfield of HE-SIG-B, the number of symbols of HE-SIG-B, or the MU-MIMO user field of HE-SIG-A. A User-specific field may be encoded separately from or independently of a common field.

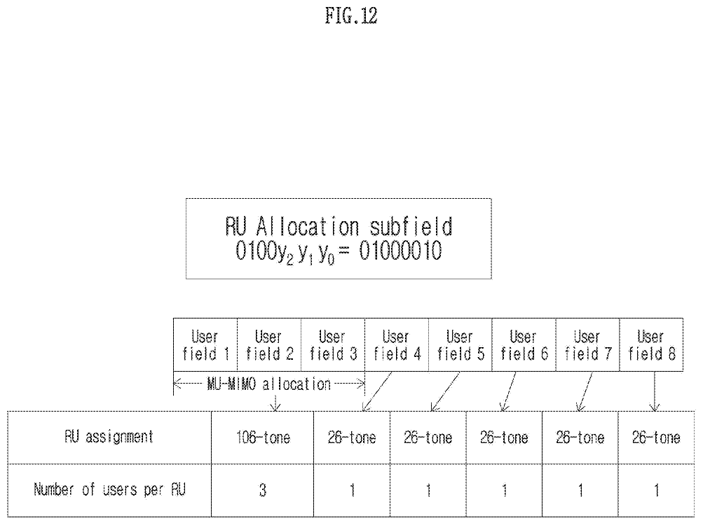

FIG. 12 is a diagram for explaining a MU-MIMO method in which a plurality of users/STAs are allocated to one RU.

In the example of FIG. 12, it is assumed that the value of the RU allocation subfield is 01000010. This corresponds to the case where y2y1y0=010 in 01000y2y1y0. 010 corresponds to 2 in decimal (i.e., N=2) and may indicate that 3 (=N+1) users are allocated to one RU. In this case, one 106-RU and five 26-RUs may be sequentially allocated from the leftmost side to the rightmost side of a specific 20 MHz band/channel. Three users/STAs may be allocated to the 106-RU in a MU-MIMO manner. As a result, a total of 8 users/STAs are allocated to the 20 MHz band/channel, and the user-specific field of HE-SIG-B may include 8 user fields (i.e., 4 user block fields). Eight user fields may be assigned to RUs as shown in FIG. 12.

The user field may be constructed based on two formats. The user field for a MU-MIMO allocation may be constructed with a first format, and the user field for non-MU-MIMO allocation may be constructed with a second format. Referring to the example of FIG. 12, user fields 1 to 3 may be based on the first format, and user fields 4 to 8 may be based on the second format. The first format and the second format may contain bit information of the same length (e.g., 21 bits).

The user field of the first format (i.e., format for MU-MIMO allocation) may be constructed as follows. For example, out of all 21 bits of one user field, B0-B10 includes the user's identification information (e.g., STA-ID, AID, partial AID, etc.), B11-14 includes spatial configuration information such as the number of spatial streams for the corresponding user, B15-B18 includes Modulation and Coding Scheme (MCS) information applied to the Data field of the corresponding PPDU, B19 is defined as a reserved field, and B20 may include information on a coding type (e.g., binary convolutional coding (BCC) or low-density parity check (LDPC)) applied to the Data field of the corresponding PPDU.

The user field of the second format (i.e., the format for non-MU-MIMO allocation) may be constructed as follows. For example, out of all 21 bits of one user field, B0-B10 includes the user's identification information (e.g., STA-ID, AID, partial AID, etc.), B11-13 includes information on the number of spatial streams (NSTS) applied to the corresponding RU, B14 includes information indicating whether beamforming is performed (or whether a beamforming steering matrix is applied), B15-B18 includes Modulation and Coding Scheme (MCS) information applied to the Data field of the corresponding PPDU, B19 includes information indicating whether DCM (dual carrier modulation) is applied, and B20 may include information on a coding type (e.g., BCC or LDPC) applied to the Data field of the corresponding PPDU.

MCS, MCS information, MCS index, MCS field, and the like used in the present disclosure may be indicated by a specific index value. For example, MCS information may be indicated as index 0 to index 11. MCS information includes information on constellation modulation type (e.g., BPSK, QPSK, 16-QAM, 64-QAM, 256-QAM, 1024-QAM, etc.), and coding rate (e.g., 1/2, 2/3, 3/4, 5/6, etc.). Information on a channel coding type (e.g., BCC or LDPC) may be excluded from the MCS information.

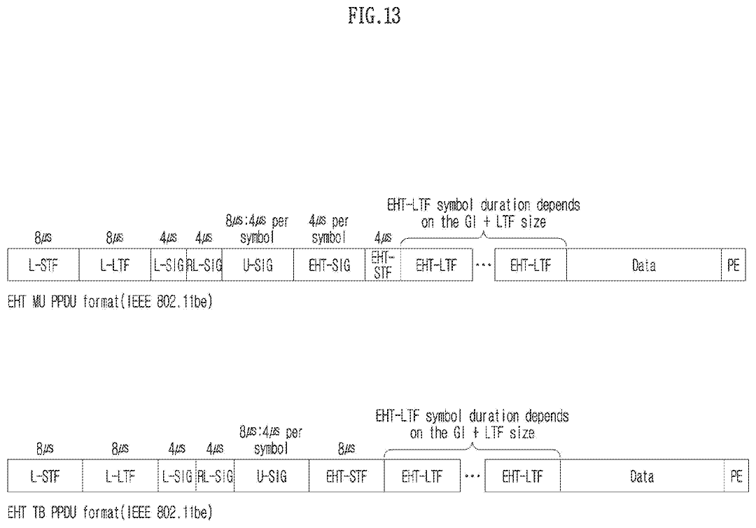

FIG. 13 illustrates an example of a PPDU format to which the present disclosure may be applied.

The PPDU of FIG. 13 may be referred as various names such as an EHT PPDU, a transmitted PPDU, a received PPDU, a first type or an N^{th} type PPDU. For example, the PPDU or EHT PPDU of the present disclosure may be referred as various names such as a transmission PPDU, a reception PPDU, a first type or an N^{th} type PPDU. In addition, the EHT PPU may be used in an EHT system and/or a new wireless LAN system in which the EHT system is improved.

The EHT MU PPDU of FIG. 13 corresponds to a PPDU carrying one or more data (or PSDUs) for one or more users. That is, the EHT MU PPDU may be used for both SU transmission and MU transmission. For example, the EHT MU PPDU may correspond to a PPDU for one receiving STA or a plurality of receiving STAs.

In the EHT TB PPDU of FIG. 13, the EHT-SIG is omitted compared to the EHT MU PPDU. Upon receiving a trigger for UL MU transmission (eg, a trigger frame or TRS), the STA may perform UL transmission based on the EHT TB PPDU format.

In the example of the EHT PPDU format of FIG. 13, L-STF to EHT-LTF correspond to a preamble or a physical preamble, and may be generated/transmitted/received/acquired/decoded in the physical layer.

A Subcarrier frequency spacing of L-STF, L-LTF, L-SIG, RL-SIG, Universal SIGNAL (U-SIG), EHT-SIG field (these are referred to as pre-EHT modulated fields) may be set to 312.5 kHz. A subcarrier frequency spacing of the EHT-STF, EHT-LTF, Data, and PE field (these are referred to as EHT modulated fields) may be set to 78.125 kHz. That is, the tone/subcarrier index of L-STF, L-LTF, L-SIG, RL-SIG, U-SIG, and EHT-SIG field may be indicated in units of 312.5 kHz, and the tone/subcarrier index of EHT-STF, EHT-LTF, Data, and PE field may be indicated in units of 78.125 kHz.

The L-LTF and L-STF of FIG. 13 may be constructed identically to the corresponding fields of the PPDU described in FIGS. 6 to 7.

The L-SIG field of FIG. 13 may be constructed with 24 bits and may be used to communicate rate and length information. For example, the L-SIG field includes a 4-bit Rate field, a 1-bit Reserved bit, a 12-bit Length field, a 1-bit Parity field, and a 6-bit Tail field may be included. For example, the 12-bit Length field may include information on a time duration or a length of the PPDU. For example, a value of the 12-bit Length field may be determined based on the type of PPDU. For example, for a non-HT, HT, VHT, or EHT PPDU, the value of the Length field may be determined as a multiple of 3. For example, for the HE PPDU, the value of the Length field may be determined as a multiple of 3+1 or a multiple of 3+2.

For example, the transmitting STA may apply BCC encoding based on a coding rate of 1/2 to 24-bit information of the L-SIG field. Thereafter, the transmitting STA may obtain 48-bit BCC coded bits. BPSK modulation may be applied to 48-bit coded bits to generate 48 BPSK symbols. The transmitting STA may map 48 BPSK symbols to any location except for a pilot subcarrier (e.g., {subcarrier index −21, −7, +7, +21}) and a DC subcarrier (e.g., {subcarrier index 0}). As a result, 48 BPSK symbols may be mapped to subcarrier indices −26 to −22, −20 to −8, −6 to −1, +1 to +6, +8 to +20, and +22 to +26. The transmitting STA may additionally map the signals of {−1, −1, −1, 1} to the subcarrier index {−28, −27, +27, +28}. The above signal may be used for channel estimation in the frequency domain corresponding to {−28, −27, +27, +28}.

The transmitting STA may construct RL-SIG which is constructed identically to L-SIG. For RL-SIG, BPSK modulation is applied. The receiving STA may recognize that the received PPDU is a HE PPDU or an EHT PPDU based on the existence of the RL-SIG.

After the RL-SIG of FIG. 13, a Universal SIG (U-SIG) may be inserted. The U-SIG may be referred as various names such as a first SIG field, a first SIG, a first type SIG, a control signal, a control signal field, and a first (type) control signal, etc.

The U-SIG may include N-bit information and may include information for identifying the type of EHT PPDU. For example, U-SIG may be configured based on two symbols (e.g., two consecutive OFDM symbols). Each symbol (e.g., OFDM symbol) for the U-SIG may have a duration of 4 us, and the U-SIG may have a total Bus duration. Each symbol of the U-SIG may be used to transmit 26 bit information. For example, each symbol of the U-SIG may be transmitted and received based on 52 data tones and 4 pilot tones.

Through the U-SIG (or U-SIG field), for example, A bit information (e.g., 52 un-coded bits) may be transmitted, the first symbol of the U-SIG (e.g., U-SIG-1) may transmit the first X bit information (e.g., 26 un-coded bits) of the total A bit information, and the second symbol of the U-SIG (e.g., U-SIG-2) may transmit the remaining Y-bit information (e.g., 26 un-coded bits) of the total A-bit information. For example, the transmitting STA may obtain 26 un-coded bits included in each U-SIG symbol. The transmitting STA may generate 52-coded bits by performing convolutional encoding (e.g., BCC encoding) based on a rate of R=1/2, and perform interleaving on the 52-coded bits. The transmitting STA may generate 52 BPSK symbols allocated to each U-SIG symbol by performing BPSK modulation on the interleaved 52-coded bits. One U-SIG symbol may be transmitted based on 56 tones (subcarriers) from subcarrier index −28 to subcarrier index+28, except for DC index 0. The 52 BPSK symbols generated by the transmitting STA may be transmitted based on the remaining tones (subcarriers) excluding pilot tones −21, −7, +7, and +21 tones.

For example, the A bit information (e.g., 52 un-coded bits) transmitted by the U-SIG includes a CRC field (e.g., a 4-bit field) and a tail field (e.g., 6 bit-length field). The CRC field and the tail field may be transmitted through the second symbol of the U-SIG. The CRC field may be constructed based on 26 bits allocated to the first symbol of U-SIG and 16 bits remaining except for the CRC/tail field in the second symbol, and may be constructed based on a conventional CRC calculation algorithm. In addition, the tail field may be used to terminate the trellis of the convolution decoder, and for example, the tail field may be set to 0.

A bit information (e.g., 52 un-coded bits) transmitted by the U-SIG (or U-SIG field) may be divided into version-independent bits and version-dependent bits. For example, a size of the version-independent bits may be fixed or variable. For example, the version-independent bits may be allocated only to the first symbol of U-SIG, or the version-independent bits may be allocated to both the first symbol and the second symbol of U-SIG. For example, the version-independent bits and the version-dependent bits may be referred as various names such as a first control bit and a second control bit, etc.

For example, the version-independent bits of the U-SIG may include a 3-bit physical layer version identifier (PHY version identifier). For example, the 3-bit PHY version identifier may include information related to the PHY version of the transmitted/received PPDU. For example, the first value of the 3-bit PHY version identifier may indicate that the transmission/reception PPDU is an EHT PPDU. In other words, when transmitting the EHT PPDU, the transmitting STA may set the 3-bit PHY version identifier to a first value. In other words, the receiving STA may determine that the received PPDU is an EHT PPDU based on the PHY version identifier having the first value.

For example, the version-independent bits of U-SIG may include a 1-bit UL/DL flag field. A first value of the 1-bit UL/DL flag field is related to UL communication, and a second value of the UL/DL flag field is related to DL communication.

For example, the version-independent bits of the U-SIG may include information on the length of a transmission opportunity (TXOP) and information on a BSS color ID.

For example, if the EHT PPDU is classified into various types (e.g., EHT PPDU related to SU mode, EHT PPDU related to MU mode, EHT PPDU related to TB mode, EHT PPDU related to Extended Range transmission, etc.), information on the type of EHT PPDU may be included in the version-dependent bits of the U-SIG.

For example, the U-SIG may include information on 1) a bandwidth field containing information on a bandwidth, 2) a field containing information on a MCS scheme applied to EHT-SIG, 3) an indication field containing information related to whether the DCM technique is applied to the EHT-SIG, 4) a field containing information on the number of symbols used for EHT-SIG, 5) a field containing information on whether EHT-SIG is constructed over all bands, 6) a field containing information on the type of EHT-LTF/STF, and 7) a field indicating the length of EHT-LTF and CP length.

Preamble puncturing may be applied to the PPDU of FIG. 13. Preamble puncturing may mean transmission of a PPDU for which no signal is present in one or more 20 MHz subchannels among the bandwidth of the PPDU. Preamble puncturing may be applied to a PPDU transmitted to one or more users. For example, the resolution of preamble puncturing may be 20 MHz for EHT MU PPDUs in OFDMA transmissions with bandwidths greater than 40 MHz and non-OFDMA transmissions with 80 MHz and 160 MHz bandwidths. That is, in the above case, puncturing on a subchannel smaller than 242-tone RU may not be allowed. In addition, for an EHT MU PPDU in non-OFDMA transmission with a bandwidth of 320 MHz, the resolution of preamble puncturing may be 40 MHz. That is, puncturing for a subchannel smaller than 484-tone RU in a 320 MHz bandwidth may not be allowed. In addition, preamble puncturing may not be applied to the primary 20 MHz channel in the EHT MU PPDU.

For example, for an EHT MU PPDU, information on preamble puncturing may be included in the U-SIG and/or the EHT-SIG. For example, the first field of the U-SIG may include information on the contiguous bandwidth of the PPDU, and the second field of the U-SIG may include information on preamble puncturing applied to the PPDU.

For example, the U-SIG and the EHT-SIG may include information on preamble puncturing based on the following method. If the bandwidth of the PPDU exceeds 80 MHz, the U-SIG may be individually constructed in units of 80 MHz. For example, if the bandwidth of the PPDU is 160 MHz, the PPDU may include a first U-SIG for a first 80 MHz band and a second U-SIG for a second 80 MHz band. In this case, the first field of the first U-SIG includes information on the 160 MHz bandwidth, and the second field of the first U-SIG includes information on preamble puncturing applied to the first 80 MHz band (i.e., information on a preamble puncturing pattern). In addition, the first field of the second U-SIG includes information on a 160 MHz bandwidth, and the second field of the second U-SIG includes information on preamble puncturing applied to a second 80 MHz band (i.e., information on a preamble puncturing pattern). The EHT-SIG following the first U-SIG may include information on preamble puncturing applied to the second 80 MHz band (i.e., information on a preamble puncturing pattern), and the EHT-SIG following the second U-SIG may include information on preamble puncturing applied to the first 80 MHz band (i.e., information on a preamble puncturing pattern).

Additionally or alternatively, the U-SIG and the EHT-SIG may include information on preamble puncturing based on the following method. The U-SIG may include information on preamble puncturing for all bands (i.e., information on a preamble puncturing pattern). That is, EHT-SIG does not include information on preamble puncturing, and only U-SIG may include information on preamble puncturing (ie, information on a preamble puncturing pattern).

U-SIG may be constructed in units of 20 MHz. For example, if an 80 MHz PPDU is constructed, the U-SIG may be duplicated. That is, the same 4 U-SIGs may be included in the 80 MHz PPDU. PPDUs exceeding 80 MHz bandwidth may include different U-SIGs.

The EHT-SIG of FIG. 13 may include control information for the receiving STA. EHT-SIG may be transmitted through at least one symbol, and one symbol may have a length of 4 us. Information on the number of symbols used for EHT-SIG may be included in U-SIG.

The EHT-SIG may include technical features of HE-SIG-B described through FIGS. 11 and 12. For example, EHT-SIG, like the example of FIG. 8, may include a common field and a user-specific field. The Common field of the EHT-SIG may be omitted, and the number of user-specific fields may be determined based on the number of users.

As in the example of FIG. 11, the common field of the EHT-SIG and the user-specific field of the EHT-SIG may be coded separately. One user block field included in the user-specific field may contain information for two user fields, but the last user block field included in the user-specific field may contain one or two user fields. That is, one user block field of the EHT-SIG may contain up to two user fields. As in the example of FIG. 12, each user field may be related to MU-MIMO allocation or non-MU-MIMO allocation.

In the same way as in the example of FIG. 11, the common field of the EHT-SIG may include a CRC bit and a Tail bit, The length of the CRC bit may be determined as 4 bits, and the length of the tail bit is determined by 6 bits and may be set to 000000.

As in the example of FIG. 11, the common field of the EHT-SIG may include RU allocation information. RU allocation information may mean information on the location of an RU to which a plurality of users (i.e., a plurality of receiving STAs) are allocated. RU allocation information may be configured in units of 9 bits (or N bits).

A mode in which a common field of EHT-SIG is omitted may be supported. The mode in which the common field of the EHT-SIG is omitted may be referred as a compressed mode. When the compressed mode is used, a plurality of users (i.e., a plurality of receiving STAs) of the EHT PPDU may decode the PPDU (e.g., the data field of the PPDU) based on non-OFDMA. That is, a plurality of users of the EHT PPDU may decode a PPDU (e.g., a data field of the PPDU) received through the same frequency band. When a non-compressed mode is used, multiple users of the EHT PPDU may decode the PPDU (e.g., the data field of the PPDU) based on OFDMA. That is, a plurality of users of the EHT PPDU may receive the PPDU (e.g., the data field of the PPDU) through different frequency bands.

EHT-SIG may be constructed based on various MCS scheme. As described above, information related to the MCS scheme applied to the EHT-SIG may be included in the U-SIG. The EHT-SIG may be constructed based on the DCM scheme. The DCM scheme may reuse the same signal on two subcarriers to provide an effect similar to frequency diversity, reduce interference, and improve coverage. For example, modulation symbols to which the same modulation scheme is applied may be repeatedly mapped on available tones/subcarriers. For example, modulation symbols (e.g., BPSK modulation symbols) to which a specific modulation scheme is applied may be mapped to first contiguous half tones (e.g., 1^{st} to 26^{th} tones) among the N data tones (e.g., 52 data tones) allocated for EHT-SIG, and modulation symbols (e.g., BPSK modulation symbols) to which the same specific modulation scheme is applied may be mapped to the remaining contiguous half tones (e.g., 27^{th} to 52^{nd} tones). That is, a modulation symbol mapped to the 1st tone and a modulation symbol mapped to the 27th tone are the same. As described above, information related to whether the DCM scheme is applied to the EHT-SIG (e.g., a 1-bit field) may be included in the U-SIG. The EHT-STF of FIG. 13 may be used to enhance automatic gain control (AGC) estimation in a MIMO environment or an OFDMA environment. The EHT-LTF of FIG. 13 may be used to estimate a channel in a MIMO environment or an OFDMA environment.

Information on the type of STF and/or LTF (including information on a guard interval (GI) applied to LTF) may be included in the U-SIG field and/or the EHT-SIG field of FIG. 13.

The PPDU (i.e., EHT PPDU) of FIG. 13 may be constructed based on an example of RU allocation of FIGS. 8 to 10.

For example, a EHT PPDU transmitted on a 20 MHz band, that is, a 20 MHz EHT PPDU may be constructed based on the RU of FIG. 8. That is, a RU location of EHT-STF, EHT-LTF, and data field included in the EHT PPDU may be determined as shown in FIG. 8. A EHT PPDU transmitted on a 40 MHz band, that is, a 40 MHz EHT PPDU may be constructed based on the RU of FIG. 9. That is, a RU location of EHT-STF, EHT-LTF, and data field included in the EHT PPDU may be determined as shown in FIG. 9.

The EHT PPDU transmitted on the 80 MHz band, that is, the 80 MHz EHT PPDU may be constructed based on the RU of FIG. 10. That is, a RU location of EHT-STF, EHT-LTF, and data field included in the EHT PPDU may be determined as shown in FIG. 10. The tone-plan for 80 MHz in FIG. 10 may correspond to two repetitions of the tone-plan for 40 MHz in FIG. 9.

The tone-plan for 160/240/320 MHz may be configured in the form of repeating the pattern of FIG. 9 or 10 several times.

The PPDU of FIG. 13 may be identified as an EHT PPDU based on the following method.

The receiving STA may determine the type of the received PPDU as the EHT PPDU based on the following. For example, when 1) the first symbol after the L-LTF signal of the received PPDU is BPSK, 2) RL-SIG in which the L-SIG of the received PPDU is repeated is detected, and 3) the result of applying the modulo 3 calculation to the value of the Length field of the L-SIG of the received PPDU (i.e., the remainder after dividing by 3) is detected as 0, the received PPDU may be determined as a EHT PPDU. When the received PPDU is determined to be an EHT PPDU, the receiving STA may determine the type of the EHT PPDU based on bit information included in symbols subsequent to the RL-SIG of FIG. 13. In other words, the receiving STA may determine the received PPDU as a EHT PPDU, based on 1) the first symbol after the L-LTF signal, which is BSPK, 2) RL-SIG contiguous to the L-SIG field and identical to the L-SIG, and 3) L-SIG including a Length field in which the result of applying modulo 3 is set to 0.

For example, the receiving STA may determine the type of the received PPDU as the HE PPDU based on the following. For example, when 1) the first symbol after the L-LTF signal is BPSK, 2) RL-SIG in which L-SIG is repeated is detected, and 3) the result of applying modulo 3 to the length value of L-SIG is detected as 1 or 2, the received PPDU may be determined as a HE PPDU.

For example, the receiving STA may determine the type of the received PPDU as non-HT, HT, and VHT PPDU based on the following. For example, when 1) the first symbol after the L-LTF signal is BPSK and 2) RL-SIG in which L-SIG is repeated is not detected, the received PPDU may be determined as non-HT, HT, and VHT PPDU.

In addition, when the receiving STA detects an RL-SIG in which the L-SIG is repeated in the received PPDU, it may be determined that the received PPDU is a HE PPDU or an EHT PPDU. In this case, if the rate (6 Mbps) check fails, the received PPDU may be determined as a non-HT, HT, or VHT PPDU. If the rate (6 Mbps) check and parity check pass, when the result of applying modulo 3 to the Length value of L-SIG is detected as 0, the received PPDU may be determined as an EHT PPDU, and when the result of Length mod 3 is not 0, it may be determined as a HE PPDU.

The PPDU of FIG. 13 may be used to transmit and receive various types of frames. For example, the PPDU of FIG. 13 may be used for (simultaneous) transmission and reception of one or more of a control frame, a management frame, or a data frame.

Hereinafter, the U-SIG included in the EHT PPDU will be described in more detail.

For a 40 MHz EHT PPDU or Extended Range (ER) preamble, the U-SIG content is the same in both 20 MHz subchannels. For an 80 MHz EHT PPDU or ER preamble, the U-SIG content is the same in all non-punctured 20 MHz subchannels. For a 160/320 MHz EHT PPDU or ER preamble, the U-SIG content is the same on all non-punctured 20 MHz subchannels within each 80 MHz subblock and may be different from the U-SIG content in other 80 MHz subblocks.

The U-SIG-1 part of the U-SIG of the EHT MU PPDU may include PHY version identifier (B0-B2), BW (B3-B5), UL/DL (B6), BSS color (B7-B12), and TXOP (B13-B19), and U-SIG-2 part may include PPDU type and compression mode (B0-B1), validate (B2), punctured channel information (B3-B7), validate (B8), EHT-SIG MCS (B9-B10), number of EHT-SIG symbols (B11-B15), CRC (B16-B19), and pail (B20-B25).

Here, an example of a 5-bit punctured channel indication for a non-OFDMA case in the EHT MU PPDU is shown in Table 1 below.

TABLE 1

| PPDU | | Punturing | |
|---|---|---|---|
| bandwidth | Cases | pattern | Field value |
| 20/40 MHz | No puncturing | [1 1 1 1] | 0 |
| 80 MHz | No puncturing | [1 1 1 1] | 0 |
| | No puncturing | [x 1 1 1] | 1 |
| | | [1 x 1 1] | 2 |
| | | [1 1 x 1] | 3 |
| | | [1 1 1 x] | 4 |
| 160 MHz | No puncturing | [1 1 1 1 1 1 1 1] | 0 |
| | 20 MHz | [x 1 1 1 1 1 1 1] | 1 |
| | puncturing | [1 x 1 1 1 1 1 1] | 2 |
| | | [1 1 x 1 1 1 1 1] | 3 |
| | | [1 1 1 x 1 1 1 1] | 4 |
| | | [1 1 1 1 x 1 1 1] | 5 |
| | | [1 1 1 1 1 x 1 1] | 6 |
| | | [1 1 1 1 1 1 x 1] | 7 |
| | | [1 1 1 1 1 1 1 x] | 8 |
| | 40 MHz | [x x 1 1 1 1 1 1] | 9 |
| | puncturing | [1 1 x x 1 1 1 1] | 10 |
| | | [1 1 1 1 x x 1 1] | 11 |
| | | [1 1 1 1 1 1 x x] | 12 |
| 320 MHz | No puncturing | [1 1 1 1 1 1 1 1] | 0 |
| | 40 MHz | [x 1 1 1 1 1 1 1] | 1 |
| | puncturing | [1 x 1 1 1 1 1 1] | 2 |
| | | [1 1 x 1 1 1 1 1] | 3 |
| | | [1 1 1 x 1 1 1 1] | 4 |
| | | [1 1 1 1 x 1 1 1] | 5 |
| | | [1 1 1 1 1 x 1 1] | 6 |
| | | [1 1 1 1 1 1 x 1] | 7 |
| | | [1 1 1 1 1 1 1 x] | 8 |
| | 80 MHz | [x x 1 1 1 1 1 1] | 9 |
| | puncturing | [1 1 x x 1 1 1 1] | 10 |
| | | [1 1 1 1 x x 1 1] | 11 |
| | | [1 1 1 1 1 1 x x] | 12 |
| | 320-80-40 | [x x x 1 1 1 1 1] | 13 |
| | | [x x 1 x 1 1 1 1] | 14 |
| | | [x x 1 1 x 1 1 1] | 15 |
| | | [x x 1 1 1 x 1 1] | 16 |
| | | [x x 1 1 1 1 x 1] | 17 |
| | | [x x 1 1 1 1 1 x] | 18 |
| | | [x 1 1 1 1 1 x x] | 19 |
| | | [1 x 1 1 1 1 x x] | 20 |
| | | [1 1 x 1 1 1 x x] | 21 |
| | | [1 1 1 x 1 1 x x] | 22 |
| | | [1 1 1 1 x 1 x x] | 23 |
| | | [1 1 1 1 1 x x x] | 24 |

In the puncturing pattern of Table 1, 1 denotes a non-punctured subchannel, and x denotes a punctured subchannel. The puncturing granularity for the 80 MHz and 160 MHz PPDU bandwidths may be 20 MHz, and the puncturing granularity for the 320 MHz PPDU bandwidth may be 40 MHz.

Next, the U-SIG-1 part of the U-SIG of the EHT TB PPDU may include a version identifier (B0-B2), BW (B3-B5), UL/DL (B6), BSS color (B7-B12), TXOP (B13-B19), and disregard (B20-B25), and U-SIG-2 part may include PPDU type and compression mode (B0-B1), validate (B2), spatial reuse 1 (B3-B6), spatial reuse 2 (B7-B10), disregard (B11-B15), CRC (B16-B19), and tail (B20-B25).

As described above, the U-SIG field of the EHT MU PPDU includes 5-bit punctured channel information, but the EHT TB PPDU does not include punctured channel information. This is because it is assumed that the EHT TB PPDU is constructed according to resource allocation indicated by the trigger frame or TRS control information, so the STA does not need to inform the AP of the resource information of the EHT TB PPDU.

In addition, even if the trigger frame or TRS control information as described above is received, the STA may not respond with the HE TB PPDU. For example, if, in the non-AP STA, a common information field included in the trigger frame or one or more subfields of an user field addressed to the non-AP STA or selected by the non-AP STA are not recognized, supported, or have an unsatisfied value, the corresponding non-AP STA may choose not to respond to the trigger frame. Similarly, if, in the non-AP STA, a TRS control subfield included in a frame addressed to the non-AP STA is not recognized by the non-AP STA, is not supported, or has an unsatisfied value, the corresponding non-AP STA may choose not to respond to the TRS control subfield.

### A-Control Subfield

The HT Control field in the MAC header may have various types/variants, and as an example, may have three forms: HT variant, VHT variant, and HE variant.

Among the 32 bits (B0-B31) of the HT Control field, the first two bits (B0 and B1) may be used to indicate a variant of the HT Control field. For example, if the B0 value is 0, the HT variant HT Control field may be indicated. If the B0 value is 1 and the B1 value is 0, the VHT variant HT Control field may be indicated. If both B0 and B1 values are 1, the HE variant HT Control field may be indicated.

Here, in the case of the HE variant HT Control field, the remaining bits (B2-B31) correspond to the A-Control subfield.

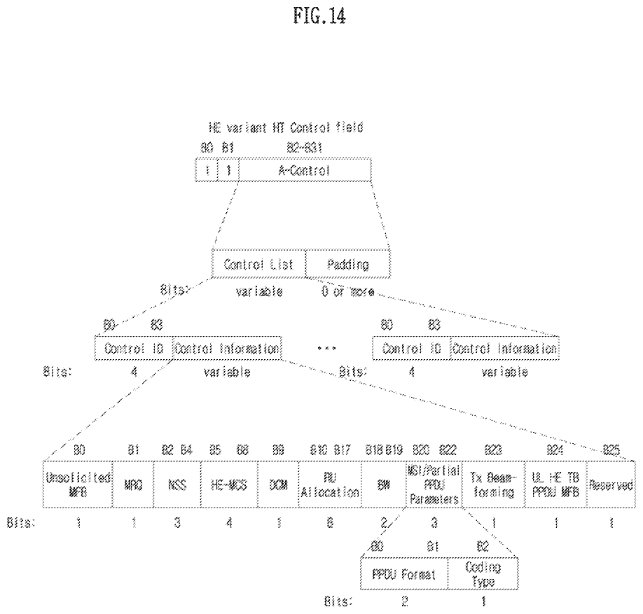

FIG. 14 illustrates an example of the A-Control subfield to which the present disclosure may be applied.

The A-Control subfield of the HE variant HT control field has a length of 30 bits and includes a control list subfield and padding bits.

The Control list subfield includes one or more Control subfields, and each Control subfield consists of a Control ID subfield and Control Information. The Padding subfield follows the last Control subfield (if present) and is set to a sequence of 0s so that the A-Control subfield is 30 bits long.

The Control ID subfield indicates the type of information carried in the Control Information subfield. The length of the Control Information subfield is fixed for the value of each Control ID subfield.

The length of the Control Information subfield related to the value of the Control ID subfield is shown in Table 2 below.

TABLE 2

| | | Length of |
|---|---|---|
| | | Control |
| Contro ID | | Information |
| value | Meaning | subfield (Bits) |
| 0 | Triggered response scheduling | 26 |
| | (TRS) | |
| 1 | Operating mode (OM) | 12 |
| 2 | HE link adaptation (HLA) | 26 |
| 3 | Buffer status report (BSR) | 26 |
| 4 | UL power headroom (UPH) | 8 |
| 5 | Bandwidth query report (BQR) | 10 |
| 6 | Command and status (CAS) | 8 |
| 7-14 | Reserved | |
| 15 | Ones need expansion surely | 26 |
| | (ONES) | |

Referring to Table 2, for example, as in the example of FIG. 14, if the Control ID subfield value is 2, HE link adaptation (HLA) information is carried in the Control Information subfield. The length of the Control Information subfield is fixed to 26 bits.

The Control Information subfield in the HLA Control subfield (i.e., the Control subfield with a Control ID subfield value of 2) contains information related to the HE Link Adaptation (HLA) procedure. The format of the Control Information subfield in the HLA Control subfield is as shown in FIG. 14.
Unsolicited MCS feedback (MFB) subfield (B0) indicates an unsolicited MFB indicator. If HLA Control is an unsolicited MFB, it is set to 1, and if HLA Control is an MRQ (MCS request) or an unsolicited MFB, it is set to 0.
The MRQ subfield (B1) indicates an HLA feedback request indicator.

To request HLA feedback, this subfield is set to 1, and the Unsolicited MFB subfield is set to 0. On the other hand, in order to respond to an HLA request, this subfield is set to 0, and the Unsolicited MFB subfield is set to 0.

If the Unsolicited MFB subfield is 1, the MRQ subfield is reserved.
The number of spatial streams (NSS) subfields (B2-B4) indicate the number of recommended spatial streams.

If the Unsolicited MFB subfield is 1 and the UL HE TB PPDU MFB subfield is 0, or if the Unsolicited MFB subfield is 0 and the MRQ subfield is 0, the NSS subfield is the spatial stream for the PPDU transmitted to the STA. Indicates the recommended number (N_{SS}) and is set to N_{SS}−1.

If the Unsolicited MFB subfield is 1 and the UL HE TB PPDU MFB subfield is 1, the NSS subfield indicates the recommended number of spatial streams (N_{SS}) for the HE TB PPDU transmitted to the STA, and it is set to N_{SS}−1. Otherwise, this subfield is reserved.
The HE-MCS subfield (B5-B8) indicates the recommended HE-MCS.

If the Unsolicited MFB subfield is 1 and the UL HE TB PPDU MFB subfield is 0, or if the Unsolicited MFB subfield is 0 and the MRQ subfield is 0, the HE-MCS subfield indicates the recommended HE-MCS of the PPDU transmitted to the STA and is set as the HE-MCS index.

If the Unsolicited MFB subfield is 1 and the UL HE TB PPDU MFB subfield is 1, the HE-MCS subfield indicates the recommended HE-MCS of the HE TB PPDU transmitted to the STA and is set as the HE-MCS index.
The DCM subfield (B9) indicates the recommended usage of dual carrier modulation (DCM).

If the Unsolicited MFB subfield is 1 and the UL HE TB PPDU MFB subfield is 0, or if the Unsolicited MFB subfield is 0 and the MRQ subfield is 0, the DCM subfield indicates the recommended use of DCM. If DCM is recommended for the PPDU transmitted to the STA, it is set to 1, otherwise it is set to 0.
The RU Allocation subfields (B10-B17) indicate the RU of the RU/recommended HE-MCS specified by the MFB requester to obtain feedback.

If the Unsolicited MFB subfield is 1 and the UL HE TB PPDU MFB subfield is 0, the RU Allocation subfield indicates the RU to which the recommended HE-MCS is applied to the PPDU transmitted to the STA.

If the Unsolicited MFB subfield is 0 and the MRQ subfield is 1, the RU Allocation subfield indicates the RU requested by the MFB requester to obtain feedback. The RU Allocation subfield is interpreted together with the BW subfield to specify the RU.

If the Unsolicited MFB subfield is 1 and the UL HE TB PPDU MFB subfield is 1, the RU Allocation subfield indicates the RU to which the recommended HE-MCS is applied to the HE TB PPDU transmitted from the STA, and the actual allocation of the RU may be ignored by the receiver.

Otherwise, this subfield is reserved.
The bandwidth (BW) subfield (B18-B19) indicates the bandwidth/recommended HE-MCS bandwidth specified by the MFB requester to obtain feedback.

If the Unsolicited MFB subfield is 1 and the UL HE TB PPDU MFB subfield is 0, the BW subfield indicates the bandwidth for applying the recommended HE-MCS to the PPDU transmitted to the STA.

If the Unsolicited MFB subfield is 0 and the MRQ subfield is 1, the BW subfield indicates the bandwidth requested by the MFB requester to obtain feedback.

Set to 0 for 20 MHz, set to 1 for 40 MHz, and set to 2 for 80 MHz.
The MSI/Partial PPDU parameters subfields (B20-B22) indicate partial parameters/MRQ sequence identifier of the measured PPDU.

If the Unsolicited MFB subfield is 0 and the MRQ subfield is 1, the MSI/Partial PPDU parameters subfield contains a sequence number (within the range 0 to 6) that identifies the specific HE-MCS feedback request. If the Unsolicited MFB subfield is 0 and the MRQ subfield is 0, the MSI/Partial PPDU parameters subfield contains the sequence number in response to the specific solicited HE-MCS feedback request (within the range 0 to 6).

If the Unsolicited MFB subfield is 1, the MSI/Partial PPDU parameters subfield includes a PPDU Format subfield and a Coding Type subfield, as shown in FIG. 14.

The PPDU Format subfield indicates the format of the PPDU in which the unsolicited MFB was estimated. It is set to 0 for HE SU PPDU, and is set to 0 for HE MU PPDU. It is set to 2 for HE ER SU PPDU, and is set to 3 for HE TB PPDU.

The Coding Type subfield includes coding information of the PPDU for which the unsolicited MFB was estimated. It is set to 0 for BCC and 1 for LDPC.
The transmission beamforming (Tx Bemaforming) subfield (B23) indicates the transmission type of the measured PPDU.

If the Unsolicited MFB subfield is 1 and the UL HE TB PPDU MFB subfield is 0, the Tx Beamforming subfield indicates whether the PPDU for which the unsolicited MFB was estimated is beamformed. It is set to 0 for non-beamformed PPDUs, and is set to 1 for beamformed PPDUs.

Otherwise, this subfield is reserved.
The uplink HE TB PPDU MFB (UL HE TB PPDU MFB) subfield (B24) indicates the UL HE TB PPDU MFB (MCS feedback).

If the Unsolicited MFB subfield is 1, a value of 1 in this subfield indicates that the NSS, HE-MCS, DCM, BW, and RU Allocation subfields indicate the recommended MFB for the HE TB PPDU transmitted from the STA. Otherwise, this subfield is reserved.

### Link Adaptation Using HLA Control Subfield

An STA that supports HE link adaptation using the HLA Control subfield depends on its link adaptation feedback capability, set the HE Link Adaption Support subfield in the HE Capabilities Information field in the HE Capabilities element to 2 or 3. The STA does not transmit MRQ to STA(s) that do not set the HE Link Adaption Support subfield in the HE Capabilities Information field in the HE Capabilities element to 3. The STA does not transmit an unsolicited MFB within any frame including the HLA Control subfield to STA(s) that do not set the HE Link Adaption Support subfield in the HE Capabilities Information field in the HE Capabilities element to 2 or 3.

The MFB requester (STA, non-STA) may request the STA to provide link adaptation feedback by setting the MRQ subfield to 1 and the Unsolicited MFB subfield to 0 in the HLA Control subfield of the frame. In each request, the MFB requester shall set the MSI field to a value between 0 and 6.

When receiving the HLA Control subfield in which the MRQ subfield is 1, the MFB responder calculates the HE-MCS, NSS, and DCM of the RU and BW specified in the MRQ, and these estimates are based on the same RU as the PPDU carrying the MRQ. The PPDU carrying the MRQ contains the requested RU for the MFB. The MFB responder labels the results of this calculation with the MSI value from the HLA Control subfield of the received frame carrying the MRQ. The MFB responder may include the received MSI value in the MSI field of the corresponding response frame. In case of delayed response, this allows the MFB requester to associate the MFB with the solicited MRQ.

The MFB responder transmitting the solicited MFB must set the Unsolicited MFB subfield to 0 and the MRQ subfield to 0 in the HLA Control subfield.

The STA receiving the MFB may calculate the appropriate HE-MCS, DCM, and NSS using the received MFB.

The MFB responder may send a solicited response frame with one of the following combinations of HE-MCS, NSS, and MSI.
HE-MCS=15, NSS=7, MSI=0-6: Responder does not provide feedback for requests with MSI value.
HE-MCS=valid value, NSS=valid value, MSI=0-6: Responder provides feedback on requests with MSI value. The MSI value of the response frame matches the MSI value of the MRQ request.

An STA that sends an unsolicited MFB using the HLA Control subfield must set the Unsolicited MFB subfield to 1.

The unsolicited HE-MCS, NSS, DCM, BW, and RU estimates reported in the HLA Control subfield transmitted by the STA are calculated based on the most recent PPDU received by the STA corresponding to the description indicated by the PPDU Format, Tx Beamforming, and Coding Type subfields in the HLA Control subfield.

In the unsolicited MFB response, the PPDU Formats, Coding Type and Tx Beamforming subfields are set according to the RXVECTOR parameters of the received PPDU for which HE-MCS, RU, BW and NSS are estimated as follows:
i) The PPDU format subfield is set and encoded as follows:
   0 if the parameter FORMAT equals HE_SU
   1 if the parameter FORMAT equals HE_MU
   2 if the parameter FORMAT equals HE_ER_SU
   3 if the parameter FORMAT equals HE_TB
ii) The Coding Type subfield is set to 0 if the FEC_CODING parameter is equal to BCC_CODING, and is set to 1 if the parameter is equal to LDPC_CODING.
iii) The Tx Beamforming subfield is set to 1 if the BEAMFORMED parameter is 1, and is set to 0 if the parameter is 0.
iv) The BW subfield indicates a bandwidth that is less than or equal to the bandwidth indicated by the CH_BANDWIDTH parameter.
v) The RU subfield indicates the RU to which the recommended HE-MCS is applied. The recommended RU must be within the bandwidth where the RU or received HE PPDU is located.

The recommended HE-MCS and NSS subfields of the HLA Control subfield for a solicited response or an unsolicited response are selected from the set of HE-MCS and NSS supported by the recipient STA.

The HE-MCS subfield of the HLA Control subfield is the recommended data rate for a given transmission attribute conveyed in the RXVECTOR of the PPDU used for MFB estimation, when the MPDU length is 3895 octets, the estimated frame error rate is less than 10%.

If the MFB requester sets the MRQ subfield to 1 and sets the MSI subfield to a value that matches the MSI subfield value of a previous request for which the responder has not yet provided feedback, the responder discards or abandons the calculation for the MRQ, which corresponds to a previous use of the corresponding MSI subfield value and starts a new calculation based on the new request.

The STA may immediately respond to the current request for the MFB with a frame that includes the NSS, HE-MCS, and DCM subfields and the MSI field value corresponding to the request preceding the current request.

In order to indicate NSS, HE-MCS, DCM, BW, RU Allocation in the HLA Control field indicating the recommended MFB for HE TB PPDU transmitted from a non-AP HE STA in the HLA Control field, the non-AP HE STA sets the UL HE TB PPDU MFB to 1 and transmits it to the AP. When the AP transmits a triggering frame addressed to the STA, do not exceed the recommended RU size indicated in the Most Recently Received RU Allocation field in the HLA Control field.

### Multi-AP Link Adaptation Method

In the following description of the present disclosure, the following configuration/environment are assumed for convenience of explanation. However, this is an example, and the proposed method of the present disclosure is not limited thereto.

### 1) Multi-AP (Multi-AP) Configuration

### Master AP

The master AP initiates a technique for multiple APs to transmit cooperatively (or it is referred to as a multi-AP technique) (e.g., joint transmission (JTX)) (e.g. sending a message related to the initiation of the multi-AP technique to the STA and/or slave AP, etc.), and perform controlling the operation of the multi-AP technique (e.g., sending control messages related to multi-AP technique to STA and/or slave AP, etc.)

Additionally, the master AP may group one or more slave APs and manage links with the slave APs so that information may be shared between the grouped slave APs.

In addition, the master AP may manage the information of the BSS comprised by the slave APs and the information of one or more STAs associated with the BSS.

Hereinafter, in the present disclosure, the master AP may be referred to as a first AP, primary AP, etc.

### Slave AP

The slave AP may establishe an association with the master AP and share mutually control information (i.e., control frame transmission and reception, etc.), management information (i.e., management frame transmission and reception, etc.), and data traffic (i.e., data frame transmission and reception, etc.)

It may basically perform the same function as an AP that may establish a BSS in an existing WLAN.

Hereinafter, in this disclosure, the slave AP may be referred to as a second AP, secondary AP, etc.

### STA

As in an existing WLAN, it may be associated with a slave AP and/or a master AP and configure a BSS.

### 2) Multi-AP Environment

The master AP and slave AP may directly transmit and receive signals/frames/data traffic, etc. from each other.

Additionally, the master AP and STA may not be able to directly transmit and receive signals/frames/data traffic, etc. from each other. That is, the master AP and STA may transmit and receive signals/frames/data traffic, etc. via the slave AP.

Additionally, the slave AP (i.e., associated with the STA) and the STA can directly transmit and receive signals/frames/data traffic to each other.

Additionally, one of the slave APs can become the master AP.

The multi-AP transmission/method may refer to a technique in which one or more APs transmit and receive information/signals/frames/data frames, etc. to one or more STAs. For example, there are Coordinated TDMA (C-TDMA: Coordinated TDMA), which divides resource allocation between APs along the time axis (in the time domain); Coordinated OFDMA (C-OFDMA: Coordinated OFDMA) dividing on the frequency axis (in the frequency domain) or Coordinated Spatial Reuse (CSR) technique using spatial reuse (SR), and the like. Additionally, techniques such as Coordinated Beamforming or Joint Beamforming, in which multiple APs collaborate to simultaneously transmit signals/frames/data frames, etc., are also possible.

In the present disclosure, in order to support channel selection (by one or more APs involved in multi-AP operation (included in multi-AP configuration/setting) and/or by one or more STAs) for various Multi-AP operations, a link adaptation control field (or a frame including this field, a transmission/reception operation of a frame including this field) is proposed.

In other words, APs must have information about STAs capable of transmitting data to configure Multi-AP, each STA may be instructed to report the channel status of APs (APs detected around the STA or APs designated by the AP requesting the channel status). Here, a separate sounding technique may be used, but In order for the AP to receive detailed channel status reports from multiple APs for each STA from multiple STAs, signaling overhead is large. Therefore, the AP may indicates each STA to report the rough channel status by including a (sub) field (e.g., HT Control (HTC) field) for multi-AP link adaptation when transmitting data.

The link adaptation control (sub) field for multi-AP operation proposed in this disclosure (i.e., a field for conveying a request and/or response of the channel state for link adaptation) may be defined by various name such as Multi-AP Link Adaptation (MLA) control (sub) field, signal-to-noise ratio (SNR) control (sub) field, received signal strength indicator (RSSI) control (sub) field, etc. Hereinafter, in this disclosure, for convenience of explanation, it is referred to as a Multi-AP Link Adaptation (MLA) control (sub) field. However, this is just an example, and may have a different name as a (sub) field for delivering a request and/or response for channel status for link adaptation for multi-AP operation.

Alternatively, an existing field can be used as a (sub) field to convey a request and/or response of channel status for link adaptation for multi-AP operation. (For example, redefining an existing field, transforming an existing field, or using reserved values of an existing field, etc.).

For example, the above-described A-Control subfield (see FIG. 14) can be used as a (sub)field for conveying a request and/or response of channel status for link adaptation for multi-AP operation. there is. In this case, a Control ID for Multi-AP link adaptive control can be added as a new A-Control subfield. For example, referring to Table 2, one value among reserved values can be used as the Control ID subfield value for Multi-AP link adaptive control in the new A-control subfield.

Hereinafter, in the description of the present disclosure, the request for channel state information, channel measurement request, and request for multi-AP link adaptation (MLA) may all equally be interpreted to mean that the AP requests channel state information for multi-AP transmission and reception operations from the STA. Additionally, reporting of channel state information, reporting of channel measurement values, and MLA's response may all equally be interpreted to mean that the STA transmits channel state information for multi-AP transmission/reception to the AP.

The MLA control (sub) field may be configured to include the following information.

Here, the contents of the MLA control (sub) field (e.g., when the A-control subfield is used, the length of the Control Information subfield for the corresponding Control ID value) may be constructed with 26 bits or less.

Additionally, the MLA control (sub) field may be constructed with multiple (sub) fields within one frame. When composed of multiple (sub)fields, the number of (sub)fields that may be composed of multiple (sub)fields may be fixed. Or, a flag is defined indicating that the (sub) field is the last, it may indicate that the last (sub) field is the last by setting the flag to 0 or 1 (0 or 1 indicates that the (sub) field is the last).

When requesting multi-AP link adaptation of an AP or requesting channel state information, the MLA control (sub) field may be configured to include the following information:
For example, the AP transmits channel status (e.g., RSSI, SNR, reference signal received power (RSRP), reference signal received quality (RSRQ)) to the STA through a frame containing the MLA control (sub) field. etc.) may be instructed to measure. In this case, the MLA control (sub) field may include only information (e.g., 1-bit indicator) requesting channel measurement from the STA.
In another example, the AP may indicate the STA to measure channel status (e.g., RSSI, SNR, RSRP, RSRQ, etc.) from multiple APs through a frame containing the MLA control (sub) field. In this case, in the frame containing the MLA control (sub) field, the channel status (e.g. RSSI (e.g. For example, 8 bits), SNR (for example, 8 bits), etc.) may be indicated to be measured. Here, if the number of BSS Colors to be measured on the channel is variable, a (sub)field indicating the number may be defined, or a flag indicating that it is the last (sub)field among (sub)fields indicating BSS Color may be defined. Alternatively, if the BSS Color is set to a specific value (for example, 0) among the (sub) fields indicating the BSS Color, the corresponding (sub) field may be designated/defined as the last.

Alternatively, the AP may not specify the BSS Color, and the STA may arbitrarily measure the channel and report the BSS Color and RSSI/SNR to the AP. In this case, the first BSS Color may be designated/defined as a specific value (for example, 0) or the BSS Color (sub) field may not be defined/set separately.

In the above description, the BSS color value may be expressed with fewer bits than the bits mentioned above. For example, the BSS color may be expressed only with some bits (e.g., 3 to 5 bits, etc.) of the most significant bit (MSB) (or leftmost bit) or the least significant bit (LSB) (or rightmost bit) among the total 6 bits.

In the feedback response of the STA's multi-AP link adaptation or the feedback response of channel state information, the MLA control (sub) field may be configured to include the following information:
For example, the STA may report channel state information (e.g. RSSI, SNR, RSRP, RSRQ values, etc.) for a frame indicated by the AP or for the associated AP to the AP through a frame containing the MLA control (sub) field. (e.g. RSSI, SNR, RSRP, RSRQ values, etc.)
In another example, the STA may report channel state information (e.g., RSSI, SNR, RSRP, RSRQ value (e.g., 8 bits), etc.) measured for each indicated BSS Color to the AP through the frame including the MLA control (sub) field. Here, if the AP specifies the BSS Color through the MLA control (sub) field, the BSS color (sub) field may be omitted in the frame including the MLA control (sub) field transmitted by the STA. For example, since the STA may transmit channel state information (e.g., RSSI, SNR, RSRP, RSRQ value, etc.) in the MLA control (sub) field in the order of the BSS when requested by the AP, the AP may estimate the BSS value for each received channel state information. The STA may arbitrarily report channel status information (e.g., RSSI, SNR, RSRP, RSRQ values, etc.) for one or more BSS Colors to the AP through a frame containing the MLA control (sub) field without a request from the AP.

In the above description, the BSS color value and/or channel state information (eg, RSSI, SNR, RSRP, RSRQ value, etc.) may be expressed with a number of bits smaller than the bits mentioned above. BSS Color is the same as described previously. Channel status information (e.g., RSSI, SNR, RSRP, RSRQ values, etc.) may be expressed as 7 bits with 8 bits at double intervals by increasing the resolution (i.e., if 256 values could be expressed with 8 bits, 7 bits) Since 128 values can be expressed with bits, the interval between values that can be expressed is doubled) or it may be expressed with 6 bits at 4-fold intervals (i.e., if 256 values could be expressed with 8 bits, since 64 values can be expressed with 6 bits, the interval between values that may be expressed increases by four times). Alternatively, reducing the expression range and set it to 0 if it is below a certain value, and set it to the maximum if it is above a certain value. For example, when the STA reports SNR, reportable SNR values may be expressed in 8 bits in 0.25 increments from −10 dB to 53.75 dB. On the other hand, by setting the resolution in 0.5 dB or 1 dB units, SNR values can be expressed in 7 bits or 6 bits. Alternatively, the number of bits may be reduced by limiting the expression range from 0 dB to 31.75 dB (for example, in the case of 0.25 units, it may be expressed with 7 bits). Alternatively, the resolution for expression of channel state information may be set large and the expression range of channel state information may also be limited.

Meanwhile, in the present disclosure, reporting of the channel state (e.g. RSSI, SNR, RSRP, RSRQ values, etc.) using the MLA control (sub) field can be reported directly to the frame indicated by the STA or to the associated AP (i.e., as a response frame to the request frame). However, when measurement of other channels is required (i.e., measurement of undirected frames or channel measurement for unassociated APs), unlike existing HLA control, the STA may not be able to respond with channel state information directly in the response frame of the frame containing the request. In other words, the STA must also check frames from other APs and provide feedback. Accordingly, a response to the channel state mays be transmitted regardless of the timing of the request or whether or not the channel state for link adaptation for multi-AP operation is requested.

Alternatively, the STA may read frames such as beacons in advance and store channel state information for one or more APs (i.e., measure channels in advance without request). In this case, when a request for channel state using the MLA control (sub) field is received, the STA may respond immediately (i.e., with a response frame to the request frame) based on the stored channel state information. Or, even in this case, the STA may transmit a response (i.e., channel state information) to the AP at a specific time (for example, at a certain period or when a specific event occurs) without waiting for a request from the AP.

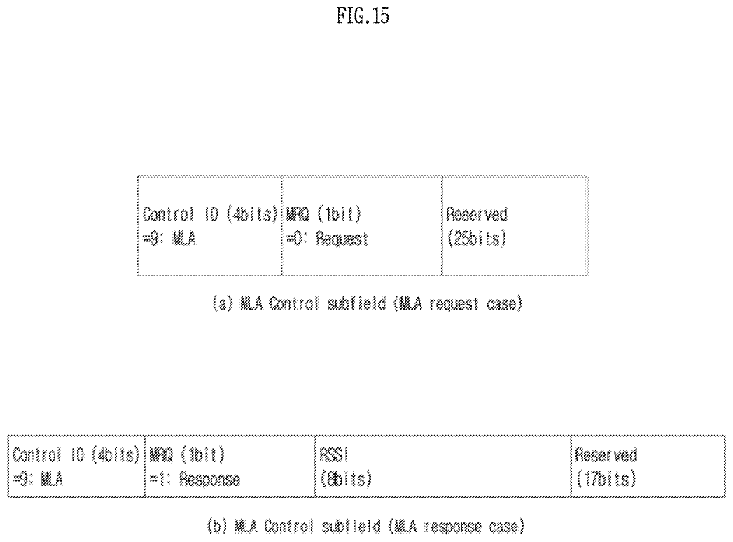

FIGS. 15 to 17 are diagrams illustrating a multi-AP link adaptation control field according to an embodiment of the present disclosure.

FIGS. 15 to 17 illustrate a case where the MLA Control subfield is included in the A-Control subfield as an example of the Multi-AP Link Adaptation (MLA) Control subfield. For example, a plurality of MLA Control subfields may be included within the A-Control subfield, or another subfield with a Control ID different from the MLA Control subfield may be included together. In other words, multiple Control subfields may be included within the Control List subfield within the A-Control subfield, and all of the plurality of Control subfields may be MLA Control subfields, or a portion of the plurality of Control subfields may correspond to the MLA Control subfield.

In addition, FIGS. 15 to 17 illustrate a case where the Control ID value for the MLA Control subfield is 9, but this is an example for convenience of explanation, and the present disclosure is not limited thereto.

In addition, FIGS. 15 to 17 illustrate a case where the MRQ subfield is used as a subfield indicating an MLA request or MLA response, but this is an example for convenience of explanation and is defined with a different name. Subfields may also be used.

In addition, FIGS. 15 to 17 illustrate a case where the length (i.e., number of bits) of one MLA Control subfield is 30 bits, but this is an example for convenience of explanation, and the MLA Control subfield The length (i.e., number of bits) may be defined/set to a length (i.e., number of bits) different from this. For example, if the length of the MLA Control subfield is defined/set to 26 bits or less, the number of reserved bits may be smaller.

In addition, FIGS. 15 to 17 illustrate the length (i.e., number of bits) of each subfield included in one MLA Control subfield, but this is an example for convenience of explanation, and the length (i.e., number of bits) of each subfield included in the MLA Control subfield may be defined/set to a different length (i.e., number of bits).

In addition, FIGS. 15 to 17 illustrate RSSI as channel state information measured and reported by the STA to the AP, but this is an example for convenience of explanation, and the present disclosure is not limited thereto. That is, in addition to RSSI, channel state information such as SNR, RSRP, and RSRQ may be reported.

Referring to FIG. 15, FIG. 15(a) illustrates the MLA Control subfield for an MLA request, and the MLA Control subfield may be defined as the Control ID subfield, MRQ subfield, and reserved subfield.

For example, the values for the Control ID subfield may be defined as shown in Table 2 above, and the Control ID subfield may be designated as the Control ID value (e.g., 9) for the MLA request/response.

The MRQ subfield may indicate whether the corresponding MLA Control subfield is an MLA request or response, and for example, 0 may indicate a request from an MLA and 1 may indicate a response from an MLA (and vice versa).

After the above-described subfields are configured, the remaining bits may be reserved.

FIG. 15(b) illustrates the MLA Control subfield for an MLA response, and the MLA Control subfield may be defined as a Control ID subfield, MRQ subfield, RSSI subfield, and reserved subfield.

Descriptions of the Control ID subfield and MRQ subfield are as shown in FIG. 15(a).

The RSSI subfield may include RSSI for the frame or AP measured by the STA. FIG. 15(b) illustrates that the RSSI subfield consists of 8 bits, but it is not limited to this, and the RSSI subfield may be of different lengths (i.e., may be defined/set by the number of bits (e.g., 6 or 7 bits).

After the above-described subfields are configured, the remaining bits may be reserved.

When the MLA Control subfield of FIG. 15 is used, the AP may transmit an MLA Control subfield (i.e., a frame including it) as shown in FIG. 15(a) to request the STA to measure channel status for multiple APs. When the STA receives the corresponding MLA Control subfield (i.e., a frame including it), the STA may recognize that channel state measurement for the multi-AP has been requested, and may transmit an MLA Control subfield (i.e., a frame including this) including an RSSI value to the AP for an MLA response.

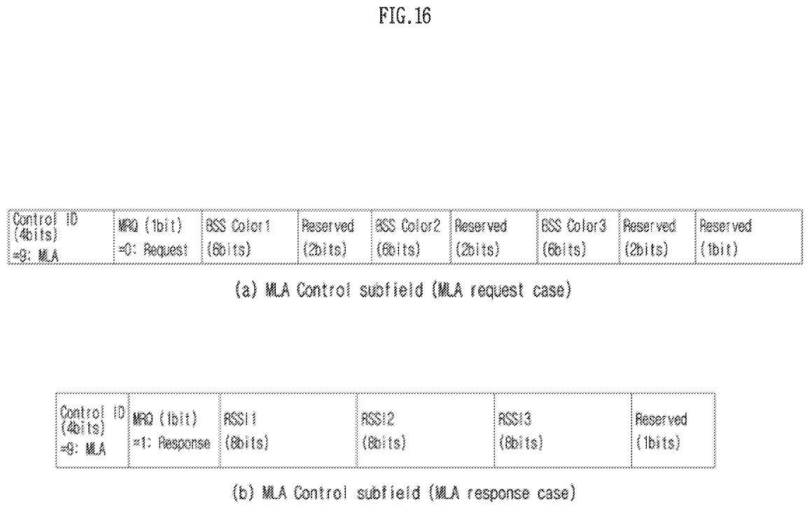

Referring to FIG. 16, FIG. 16(a) illustrates the MLA Control subfield for an MLA request, and the MLA Control subfield includes the Control ID subfield, MRQ subfield, 1st BSS Color subfield, and reserved (reserved) subfield, 2nd BSS Color subfield, reserved subfield, 3rd BSS Color subfield, reserved subfield, and reserved subfield.

The description of the Control ID subfield and MRQ subfield is as shown in FIG. 15(a).

The AP may indicate to the STA a plurality of BSS Colors of frames for which channel measurement must be performed through the BSS Color subfield. In this case, as described above, the number of BSS Colors may be fixed in advance or may be variable. If the number of BSS Colors indicated by the AP is variable, a subfield indicating the number may be defined separately (not shown), a flag may be defined to indicate that this is the last BSS Color (not shown), and a specific BSS Color value (for example, 0) may be used to indicate that it is the last BSS Color.

Reserved subfields that follow each BSS Color subfield may be used to match the spacing with the MLA Control subfield for the MLA response. In FIG. 16, the BSS Color subfield is used as 6 bits, and the RSSI subfield is used as 8 bits. Reserved subfields following each BSS Color subfield may be set to 2 bits in length. However, if each RSSI subfield is set to a length of 6 bits in the MLA Control subfield for MLA response, the reserved subfields may not be defined/set.

After the above-described subfields are configured, the remaining bits may be reserved.

FIG. 16(b) illustrates the MLA Control subfield for an MLA response, the MLA Control subfield may be defined as a Control ID subfield, MRQ subfield, 1st RSSI subfield, 2nd RSSI subfield, 3rd RSSI subfield, and reserved subfield.

Descriptions of the Control ID subfield and MRQ subfield are as shown in FIG. 15(a).

The RSSI subfield may include RSSI for the frame or AP measured by the STA.

As described above, the BSS Color subfield corresponding to each RSSI subfield may not be defined/set in the MLA Control subfield for MLA response. In this case, the order of RSSI subfields in the MLA Control subfield for the MLA response may be configured to be the same as the order of the BSS Color subfields in the MLA Control subfield for the MLA request.

FIG. 16(b) also illustrates that the RSSI subfield is composed of 8 bits, but is not limited thereto, and the RSSI subfield may be defined/set to a different length (i.e., number of bits, for example, 6 or 7 bits) by adjusting the interval, range, etc. of the RSSI value that may be expressed as described above.

After the above-described subfields are configured, the remaining bits may be reserved.

When the MLA Control subfield of FIG. 16 is used, the AP may transmit an MLA Control subfield (i.e., a frame including it) as shown in FIG. 16(a) to request channel state measurement for multiple designated BSS Colors (i.e., for specific specified APs). When the STA receives the corresponding MLA Control subfield (i.e., a frame including it), the STA may recognize the number of BSS Colors (i.e., multiple APs) for which specified channel state measurement has been requested. In addition, the STA may transmit an MLA Control subfield (i.e., a frame containing this) containing RSSI values for multiple BSS Colors (or multiple APs) (designated by the AP) to the AP for an MLA response.

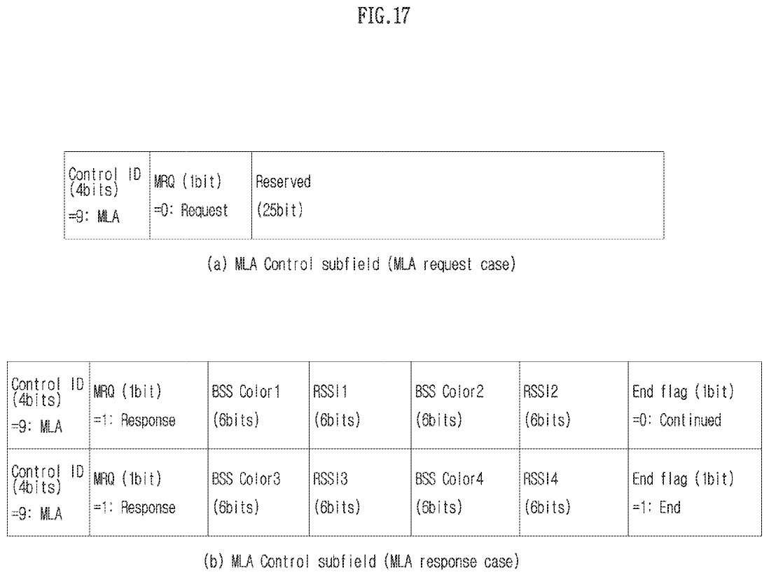

Referring to FIG. 17, FIG. 17(a) illustrates the MLA Control subfield for an MLA request, and the MLA Control subfield may be defined as a Control ID subfield, MRQ subfield, and reserved subfield.

Since the MLA Control subfield in FIG. 17(a) is the same as the MLA Control subfield in FIG. 15(a), description is omitted.

FIG. 17(b) illustrates the MLA Control subfield for an MLA response, and the MLA Control subfield may be defined as Control ID subfield, MRQ subfield, 1st BSS Color subfield, 1st RSSI subfield, 2nd BSS Color subfield, 2nd RSSI subfield, End flag subfield, 3rd BSS Color subfield, 3rd RSSI subfield, 4th BSS Color subfield, 4th RSSI subfield, reserved subfield

The description of the Control ID subfield and MRQ subfield is as shown in FIG. 15(a).

In the MLA Control subfield, the BSS Color value and RSSI, which are the targets of channel measurement by the STA, may be set together. As described above, the number of RSSI measurements by the STA may be fixed or variable. FIG. 17(b) illustrates a case where it is variable, and illustrates a case where the End flag subfield is used to indicate the last BSS Color subfield and RSSI subfield. That is, the present disclosure is not limited to the case in which four BSS Color subfields and four RSSI subfields are configured as shown in FIG. 17(b).

The End flag subfield may indicate whether the BSS Color subfield and RSSI subfield preceding the End flag subfield are the last. For example, 0 may indicate that it is not the last (i.e., continued), and 1 may indicate last (i.e. end) (and vice versa).

FIG. 17(b) also illustrates that the RSSI subfield consists of 6 bits, but is not limited thereto, and the RSSI subfield may be defined/set to a different length (i.e., number of bits, for example, 7 or 8 bits) by adjusting the interval, range, etc. of the RSSI value that may be expressed as described above.

After the above-described subfields are configured, the remaining bits may be reserved.

When the MLA Control subfield of FIG. 17 is used, the AP may transmit an MLA Control subfield (i.e., a frame including it) as shown in FIG. 16(a) to request channel state measurement for multiple APs, Here, multiple BSS Colors (i.e. multiple APs) may not be specified. When the STA receives the corresponding MLA Control subfield (i.e., a frame containing it), for an MLA response, the STA may transmit an MLA Control subfield (i.e., a frame containing this) containing RSSI values for multiple BSS Colors (i.e., multiple APs) (determined/selected by the STA) to the AP.

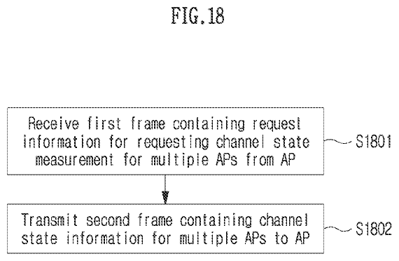

FIG. 18 is a diagram illustrating the operation of an STA for a method for transmitting and receiving channel state information according to an embodiment of the present disclosure.

FIG. 18 illustrates the operation of an STA based on one or a combination of one or more (detailed) methods among the previously proposed methods. The example in FIG. 18 is for convenience of explanation and does not limit the scope of the present disclosure. Some step(s) illustrated in FIG. 18 may be omitted depending on the situation and/or setting. Additionally, the STA in FIG. 18 is only an example and may be implemented with the device previously illustrated in FIG. 1. For example, the processors 102/202 in FIG. 1 can control transmission and reception of frames/signals/data/information, etc. using the transceivers 106/206, and may also be controlled to store frames/signals/data/information to be transmitted or received in the memory 104/204.

Referring to FIG. 18, the STA receives a first frame containing request information for requesting channel state measurement for multiple APs from the AP (51801).

The STA transmits a second frame containing channel state information on multiple APs to the AP (S1802). The channel state information may include channel measurement values for each of multiple APs measured by the STA.

In other words, the AP transmits a first frame to the STA requesting channel measurement for multiple APs (or BSSs), and the STA measures the channel using frames transmitted from multiple APs (or BSSs) and transmits a second frame including the channel measurement value to the AP.

For example, the channel measurement value may correspond to a received signal strength indicator (RSSI) value or a signal-to-noise ratio (SNR) value, but the scope of the present disclosure is limited thereto.

Here, the first frame and the second frame may correspond to any one of a data frame, a management frame, and a control frame, the same type of frame may be used, or different types of frames may be used.

The request information and the channel state information may be included in a field for multiple AP link adaptation control within the first frame and the second frame, respectively. Here, the scope of the present disclosure is not limited to the name (sub)field for multiple AP link adaptive control, and (sub)fields with other names may be used.

For example, the A-Control (A-Control) subfield in the HT Control (High Throughput Control) field may be used as a field for multi-AP link adaptive control. In this case, it may include a Control Identifier (control ID) subfield and a Control Information subfield, and, based on the Control ID subfield indicating a value (e.g., 9) for the multi-AP link adaptive control, the Control Information subfield may be used to transmit the request information or the channel state information. In addition, it may include a subfield for a identifier within the Control Information subfield (e.g., MRQ subfield), and the value of the subfield for the identifier may indicate which of the request information and the channel state information is included in the Control Information subfield (For example, 0: indicates that request information is included, 1: indicates that channel state information is included).

Multiple APs (or BSSs) to be measured by the STA may or may not be specified by request information for requesting channel state measurement within the first frame.

For example, when multiple APs (or BSS) to be measured by the STA are specified, the request information in the first frame may include subfields for basic service set color (BSS Color) values corresponding to each of multiple APs for which measurement is requested by the STA. Here, the number of subfields for the BSS Color value may be predetermined, or an end subfield may indicate that the subfields for the BSS Color value have ended. In this case, without a subfield for the BSS Color value in the second frame transmitted by the STA, as the channel state information, only subfields for each channel measurement value for the BSS Color values indicated by the request information may be included. Here, subfields for the channel measurement value may be included in the second frame in the order of subfields for the BSS Color value in the first frame.

In other words, when APs (or BSSs) that must be measured by the AP are specified (requested), the STA may measure the channel using frames for specified (requested) APs (or BSSs) and transmit the derived (obtained) channel state information to the corresponding AP.

As another example, when multiple APs (or BSS) to be measured by the STA are not specified, BSS Color values corresponding to each of multiple APs for which measurement is requested by the STA may not be included in the first frame. In this case, the second frame transmitted by the STA may include subfields for BSS Color values of frames measured by the STA and subfields for corresponding channel measurement values. Here, the frames (or APs, BSS Colors) measured by the STA may be arbitrarily selected by the STA. In this case as well, the number of subfields for the BSS Color value and the channel measurement value is predetermined or Alternatively, or the end subfield may indicate that the subfields for the BSS Color value and the channel measurement value have ended.

That is, if the APs (or BSSs) that must be measured by the AP are not specified (requested), the STA may measure the channel using frames transmitted from arbitrary APs (or BSSs) and transmit the derived (obtained) channel state information to the corresponding AP.

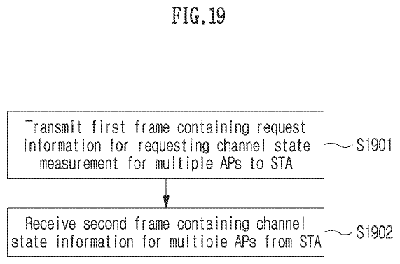

FIG. 19 is a diagram illustrating the operation of an AP in a method for transmitting and receiving channel state information according to an embodiment of the present disclosure.

FIG. 19 illustrates the operation of an AP based on one or a combination of one or more (detailed) methods among the previously proposed methods. The example in FIG. 19 is for convenience of explanation and does not limit the scope of the present disclosure. Some step(s) illustrated in FIG. 19 may be omitted depending on the situation and/or setting. Additionally, the AP in FIG. 19 is only an example and may be implemented with the device previously illustrated in FIG. 1. For example, the processors 102/202 in FIG. 1 can control transmission and reception of frames/signals/data/information, etc. using the transceivers 106/206, and may also be controlled to store frames/signals/data/information to be transmitted or received in the memory 104/204.

Referring to FIG. 19, the AP transmits a first frame containing request information for requesting channel state measurement for multiple APs to the STA (S1901).

The AP receives a second frame containing channel state information on multiple APs to the AP (S1902). The channel state information may include channel measurement values for each of multiple APs measured by the STA.

In other words, the AP transmits a first frame to the STA requesting channel measurement for multiple APs (or BSSs), and the STA measures the channel using frames transmitted from multiple APs (or BSSs) and transmits a second frame including the channel measurement value to the AP, and the AP receives a second frame containing the channel measurement value.

For example, the channel measurement value may correspond to a received signal strength indicator (RSSI) value or a signal-to-noise ratio (SNR) value, but the scope of the present disclosure is limited thereto.

Here, the first frame and the second frame may correspond to any one of a data frame, a management frame, and a control frame, the same type of frame may be used, or different types of frames may be used.

The request information and the channel state information may be included in a field for multiple AP link adaptation control within the first frame and the second frame, respectively. Here, the scope of the present disclosure is not limited to the name (sub)field for multiple AP link adaptive control, and (sub)fields with other names may be used.

For example, the A-Control (A-Control) subfield in the HT Control (High Throughput Control) field may be used as a field for multi-AP link adaptive control. In this case, it may include a Control Identifier (control ID) subfield and a Control Information subfield, and, based on the Control ID subfield indicating a value (e.g., 9) for the multi-AP link adaptive control, the Control Information subfield may be used to transmit the request information or the channel state information. In addition, it may include a subfield for a identifier within the Control Information subfield (e.g., MRQ subfield), and the value of the subfield for the identifier may indicate which of the request information and the channel state information is included in the Control Information subfield (For example, 0: indicates that request information is included, 1: indicates that channel state information is included).

Multiple APs (or BSSs) to be measured by the STA may or may not be specified by request information for requesting channel state measurement within the first frame.

For example, when multiple APs (or BSS) to be measured by the STA are specified, the request information in the first frame may include subfields for basic service set color (BSS Color) values corresponding to each of multiple APs for which measurement is requested by the STA. Here, the number of subfields for the BSS Color value may be predetermined, or an end subfield may indicate that the subfields for the BSS Color value have ended. In this case, without a subfield for the BSS Color value in the second frame transmitted by the STA, as the channel state information, only subfields for each channel measurement value for the BSS Color values indicated by the request information may be included. Here, subfields for the channel measurement value may be included in the second frame in the order of subfields for the BSS Color value in the first frame.

In other words, when APs (or BSSs) that must be measured by the AP are specified (requested), the STA may measure the channel using frames for specified (requested) APs (or BSSs) and transmit the derived (obtained) channel state information to the corresponding AP.

As another example, when multiple APs (or BSS) to be measured by the STA are not specified, BSS Color values corresponding to each of multiple APs for which measurement is requested by the STA may not be included in the first frame. In this case, the second frame transmitted by the STA may include subfields for BSS Color values of frames measured by the STA and subfields for corresponding channel measurement values. Here, the frames (or APs, BSS Colors) measured by the STA may be arbitrarily selected by the STA. In this case as well, the number of subfields for the BSS Color value and the channel measurement value is predetermined or Alternatively, or the end subfield may indicate that the subfields for the BSS Color value and the channel measurement value have ended.

That is, if the APs (or BSSs) that must be measured by the AP are not specified (requested), the STA may measure the channel using frames transmitted from arbitrary APs (or BSSs) and transmit the derived (obtained) channel state information to the corresponding AP.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

### INDUSTRIAL APPLICABILITY

A method proposed by the present disclosure is mainly described based on an example applied to an IEEE 802.11-based system, 5G system, but may be applied to various WLAN or wireless communication systems other than the IEEE 802.11-based system.

1. A method for transmitting channel state information by a station (STA) in a wireless LAN system, the method comprising:
receiving, from an access point (AP), a first frame containing request information for requesting channel state measurement for multiple APs; and
transmitting, to the AP, a second frame containing channel state information for multiple APs,
wherein the request information and the channel state information are included in fields for multiple AP link adaptation control in the first frame and the second frame, respectively, and
wherein the channel state information includes channel measurement values for each of multiple APs measured by the STA.

2. The method of claim 1,
wherein A-Control subfield in a HT Control (High Throughput Control) field is used as a field for the multiple AP link adaptive control.

3. The method of claim 2,
wherein the A-Control subfield includes a control identifier (Control ID) subfield and a Control Information subfield, and
wherein, based on the Control ID subfield indicating a value for the multiple AP link adaptive control, the Control Information subfield is used for transmission of the request information or the channel state information.

4. The method of claim 3,
wherein a subfield for a identifier in the Control Information subfield is included,
wherein a value of the subfield for the identifier indicates which of the request information and the channel state information is included in the Control Information subfield.

5. The method of claim 1,
wherein the request information in the first frame includes subfields for basic service set color (BSS Color) values corresponding to each of multiple APs for which measurement is requested by the STA.

6. The method of claim 5,
wherein the number of subfields for the BSS Color value is predetermined or an end subfield indicates that the subfields for the BSS Color value have ended.

7. The method of claim 5,
wherein only subfields for each channel measurement value for the BSS Color values indicated by the request information are included as the channel state information, without a subfield for the BSS Color value in the second frame.

8. The method of claim 7,
wherein subfields for the channel measurement value are included in the second frame in the order of subfields for the BSS Color value in the first frame.

9. The method of claim 1,
wherein, based on that BSS Color values corresponding to each of the multiple APs for which measurement is requested by the STA are not included in the first frame, subfields for BSS Color values of frames measured by the STA in the second frame and subfields for corresponding channel measurement values are included.

10. The method of claim 9,
wherein the frames measured by the STA are arbitrarily selected by the STA.

11. The method of claim 9,
wherein the number of subfields for the BSS Color value and the channel measurement value is predetermined, or an end subfield indicates that subfields for the BSS Color value and the channel measurement value have ended.

12. The method of claim 1,
wherein the channel measurement value is a received signal strength indicator (RSSI) value or a signal-to-noise ratio (SNR) value.

13. A station (STA) for transmitting channel state information in a wireless LAN system, the STA comprising:
at least one transceiver; and
at least one processor coupled with the at least one transceiver,
wherein the at least one processor is configured to:
receive, from an access point (AP), a first frame containing request information for requesting channel state measurement for multiple APs; and
transmit, to the AP, a second frame containing channel state information for multiple APs,
wherein the request information and the channel state information are included in fields for multiple AP link adaptation control in the first frame and the second frame, respectively, and
wherein the channel state information includes channel measurement values for each of multiple APs measured by the STA.

14-16. (canceled)

17. An access point (AP) for receiving channel state information in a wireless LAN system, the STA comprising:
at least one transceiver; and
at least one processor coupled with the at least one transceiver,
wherein the at least one processor is configured to:
transmit, to a station (STA), a first frame containing request information for requesting channel state measurement for multiple APs; and
receive, from the STA, a second frame containing channel state information for multiple APs,
wherein the request information and the channel state information are included in fields for multiple AP link adaptation control in the first frame and the second frame, respectively, and
wherein the channel state information includes channel measurement values for each of multiple APs measured by the STA.
